(19) United States
(12) Patent Application Publication
(10) Pub. No.: US 2026/0175241 A1
(43) Pub. Date: Jun. 25, 2026

(54) PLURAL COMPONENT SPRAYER AND CARTRIDGE FOR A PLURAL COMPONENT SPRAYER

(71) Applicant: Graco Minnesota Inc., Minneapolis, MN (US)

(72) Inventors: Christopher J. Pellin, Victoria, MN (US); Kyle A. Bottke, Plymouth, MN (US); John R. Ingebrand, New Prague, MN (US); Joseph E. Tix, Hastings, MN (US)

(21) Appl. No.: 19/125,160

(22) PCT Filed: Aug. 2, 2023
(86) PCT No.: PCT/US2023/029309

§ 371 Date: Apr. 28, 2025

Related U.S. Application Data
(60) Provisional application No. 63/422,505, filed on Nov. 4, 2022.
(60) Provisional application No. 63/444,502, filed on Feb. 9, 2023.
(60) Provisional application No. 63/459,484, filed on Apr. 14, 2023.

(51) Int. Cl. B05B 7/08

(52) U.S. Cl. CPC B05B 7/0815

(57) ABSTRACT

A plural component sprayer receives individual flows of constituent materials and combines the constituent materials together to form a plural component material for application on a surface. A cartridge includes valving for controlling the flows of the constituent materials to a mix chamber within which the constituent materials combine to form the plural component material. The cartridge is mountable to and removable from a gun body of the plural component sprayer as a single unit.

### CROSS-REFERENCE TO RELATED APPLICATION(S)

This application claims priority to U.S. Provisional Application No. 63/422,505 filed Nov. 4, 2022 and entitled “SOLVENT DOSING AND DOSE PISTON FOR A SPRAY APPLICATOR,” and claims priority to U.S. Provisional Application No. 63/444,502 filed on Feb. 9, 2023 and entitled “CARTRIDGE FOR PLURAL COMPONENT SPRAY GUN,” and claims priority to U.S. Provisional Application No. 63/459,484 filed Apr. 14, 2023 and entitled “CARTRIDGE FOR PLURAL COMPONENT SPRAYER,” the disclosures of which are hereby incorporated by reference in their entireties.

### BACKGROUND

The present disclosure concerns spraying of plural component mixtures. More particularly, the present disclosure concerns sprayers and components of sprayers that spray plural component mixtures.

Spray foam, typically created by mixing isocyanate and polyol resin components, is one broad type of sprayable plural component fluids. Plural components can also be glues, adhesives, coatings, and other materials. For example, epoxies can be sprayed. Individual constituent materials are flows to a spray gun, mixed within the spray gun to form a plural component material, and sprayed as a single solution. The single solution can be referred to as a plural component material as it is formed from the multiple constituent components.

The constituent components are typically mixed in a spray gun and then sprayed in a matter of milliseconds due to the quick reacting and setting nature of the fluids. Mixing can occur within a mix chamber within the gun. The mix chamber can form part of the nozzle of the gun in various embodiments. Due to the quick setting nature of the combined fluids, special attention has to be paid to maintenance of the guns. For example, any component residue left in a gun such as in or around the mix chamber can react when exposed to its complementary component or can otherwise dry. Clogs and other obstructions can interfere with the mechanical operation of the spray gun and interfere with proper mixing and spraying. Various aspects of the present disclosure concern improving maintenance to extend service life and/or improve spray performance, amongst others.

### SUMMARY

According to an aspect of the disclosure, a cartridge is configured for use with a plural component spray gun having a spray gun body and configured to receive first and second constituent materials that mix to form a plural component material. The cartridge includes a valving body extending between a first body end and a second body end; a first flow valve located within the valving body; a second flow valve located within the valving body; and a mix chamber cavity extending into the first body end of the valving body along a spray axis, the mix chamber cavity configured to receive at least a portion of a mix chamber of the plural component spray gun. The cartridge is removable from the spray gun body as a single module. Removal of the cartridge from the spray gun body necessarily disconnects the mix chamber from any connection with the spray gun body if the mix chamber has not already been removed from the cartridge.

According to an additional or alternative aspect of the disclosure, a plural component spray gun configured to receive a first constituent material and a second constituent material and output a spray of a plural component material includes a gun body; a handle projecting from the gun body; a trigger supported by the gun body; a cartridge removably mountable to the gun body; and a mix chamber. The cartridge includes a valving body extending between a first body end and a second body end, the second body end configured to interface with the gun body to connect the cartridge to the gun body; a first flow valve located within the valving body; a second flow valve located within the valving body; and a mix chamber cavity extending into the first body end of the valving body along a spray axis. The cartridge is removable from the spray gun body as a single module. The mix chamber is mountable within the mix chamber cavity. Removal of the cartridge from the gun body necessarily disconnects the mix chamber from any connection with the spray gun body if the mix chamber has not already been removed from the cartridge.

According to another additional or alternative aspect of the disclosure, a cartridge is configured for use with a plural component spray gun having an actuator assembly including a spray gun body and a displacer, the cartridge configured to receive first and second constituent materials that mix to form a plural component material, The cartridge including a valving body extending between a first body end and a second body end along an axis; a mix chamber cavity formed in the valving body; a first flow valve located within the valving body; a second flow valve located within the valving body; a valve mount configured to interface with the actuator assembly at a dynamic interface to receive a mechanical input to actuate the first flow valve and the second flow valve between respective first states, in which flows of the first constituent material and the second constituent material to the mix chamber cavity are closed, and respective second states, in which the flows of the first constituent material and the second constituent material to the mix chamber cavity are open; and a body mount formed on the valving body and configured to interface with the actuator assembly at a static interface to mount the cartridge to the spray gun body. The cartridge is mountable to and dismountable from the actuator assembly as a single unit.

According to yet another additional or alternative aspect of the disclosure, a cartridge is configured for use with a plural component sprayer having an actuator assembly including a spray gun body and a displacer, the cartridge configured to receive first and second constituent materials that mix to form a plural component material. The cartridge including a valving body extending between a first body end and a second body end along an axis, the valving body including a body mount configured to interface with the spray gun body to fix the valving body to the spray gun body; a mix chamber cavity formed in the valving body and open through the first body end; and a valve assembly supported by the valving body, the valve assembly movable along the axis and relative to the valving body to open and close flowpaths for the first constituent material and the second constituent material to flow to the mix chamber cavity, the valve assembly including a valve mount configured to interface with the displacer to fix the valve assembly to the displacer. The cartridge is mountable to and dismountable from the actuator assembly as a single unit.

According to yet another additional or alternative aspect of the disclosure, a cartridge for a plural component sprayer having an actuator assembly including a spray gun body and a displacer, the cartridge configured to receive first and second constituent materials that mix to form a plural component material, the cartridge including a valving body extending between a first body end and a second body end along an axis and a valve assembly. The valving body includes a block body; a mix chamber cavity extending into the block body in a first axial direction along to the axis; a first valve bore extending into the block body in a second axial direction along to the axis, wherein a first flow chamber configured to receive the first constituent material and a first gas chamber are disposed within the first valve bore, and wherein the second axial direction is opposite the first axial direction; a second valve bore extending into the block body in the second axial direction, wherein a second flow chamber configured to receive the second constituent material and a second gas chamber are disposed within the second valve bore; a gas passage extending into the block body in the second axial direction; and a body mount configured to interface with the spray gun body to fix the valving body to the spray gun body. The valve assembly is supported by the valving body and includes a first valve member at least partially disposed in the first valve bore, the first valve member movable relative to the block body between a first member first state in which the first gas chamber is fluidly connected to the mix chamber cavity and the first flow chamber is fluidly disconnected from the mix chamber cavity, and a first member second state in which the first flow chamber is fluidly connected to the mix chamber cavity and the first gas chamber is fluidly disconnected from the mix chamber cavity; a second valve member at least partially disposed in the second valve bore, the second valve member movable relative to the block body between a second member first state in which the second gas chamber is fluidly connected to the mix chamber cavity and the second flow chamber is fluidly disconnected from the mix chamber cavity, and a second member second state in which the second flow chamber is fluidly connected to the mix chamber cavity and the second gas chamber is fluidly disconnected from the mix chamber cavity; and a valve mount configured to interface with the displacer to fix the valve assembly to the displacer. The cartridge is mountable to and dismountable from the actuator assembly as a single unit.

According to yet another additional or alternative aspect of the disclosure, a plural component spray gun configured to receive a first constituent material and a second constituent material and output a spray of a plural component material includes an actuator assembly including a gun body and a displacer movable relative to the gun body along an axis; and a cartridge removably mountable to the actuator assembly by a static interface formed between the cartridge and the gun body and a dynamic interface formed between the cartridge and the displacer, the dynamic interface configured to actuate a first flow valve of the cartridge to control a flow of the first constituent material to a mix chamber cavity formed in the cartridge and the dynamic interface configured to actuate a second flow valve of the cartridge to control a flow of the second constituent material to the mix chamber cavity. The cartridge is mountable to and dismountable from the actuator assembly as a single unit.

According to yet another additional or alternative aspect of the disclosure, a cartridge is configured for use with a plural component spray gun having an actuator assembly including a spray gun body and a displacer, the cartridge configured to receive first and second constituent materials that mix to form a plural component material. The cartridge includes a valving body extending between a first body end and a second body end along an axis; a mix chamber cavity formed in the valving body and open through the first body end; a first valve bore formed in the valving body and open through the second body end; a second valve bore formed in the valving body and open through the second body end; a valve assembly supported by the valving body and including a first valve member at least partially disposed within the first valve bore and a second valve member at least partially disposed within the second valve bore; a first flow valve formed within the first valve bore, the first valve member forming a movable valving component of the first flow valve; and a second flow valve formed within the second valve bore, the second valve member forming a movable valving component of the second flow valve. The valve assembly is movable relative to the valving body to actuate the first flow valve and the second flow valve between respective first states, in which a flow of the first constituent material and a flow of the second constituent material to the mix chamber cavity are blocked, and respective second states, in which the flow of the first constituent material and the flow of the second constituent material to the mix chamber cavity are unblocked. The cartridge is mountable to and dismountable from the actuator assembly as a single unit.

According to yet another additional or alternative aspect of the disclosure, a cartridge is configured for use with a plural component spray gun having an actuator assembly including a spray gun body and a displacer, the cartridge configured to receive first and second constituent materials that mix to form a plural component material. The cartridge includes a valving body extending between a first body end and a second body end along an axis; a mix chamber cavity formed in the valving body and open through the first body end; a first valve bore formed in the valving body and open through the second body end; a second valve bore formed in the valving body and open through the second body end; and a valve assembly supported by the valving body. The valve assembly includes a coupler at least partially disposed within the valving body; a first valve member connected to the coupler and at least partially disposed within the first valve bore; and a second valve member connected to the coupler and at least partially disposed within the second valve bore. The coupler is configured to transmit force to the first valve member to displace the first valve member along the first valve bore between a first member first state, in which flow of the first constituent material to the mix chamber cavity is blocked such that the first constituent material is prevented from flowing to the mix chamber cavity, and a first member second state, in which flow of the first constituent material to the mix chamber cavity is unblocked such that the first constituent material is able to flow to the mix chamber cavity. The coupler is configured to transmit force to the second valve member to displace the second valve member along the second valve bore between a second member first state, in which flow of the second constituent material to the mix chamber cavity is blocked such that the second constituent material is prevented from flowing to the mix chamber cavity, and a second member second state, in which flow of the second constituent material to the mix chamber cavity is unblocked such that the second constituent material is able to flow to the mix chamber cavity. The cartridge is mountable to and dismountable from the actuator assembly as a single unit such that the valving body and the valve assembly mount together and dismount together.

According to yet another additional or alternative aspect of the disclosure, a plural component sprayer configured to receive a first constituent material and a second constituent material and emit a spray of a plural component material formed by combining the first constituent material and the second constituent material, the plural component sprayer including a gun body; a displacer disposed at least partially within the gun body; a mix chamber configured to receive the first constituent material and the second constituent material and emit the plural component material; a cartridge mountable to and dismountable from the gun body and the displacer as a single unit. The cartridge includes a valving body extending between a first body end and a second body end along an axis; a mix chamber cavity formed in the valving body and open through the first body end, the mix chamber disposed at least partially within the mix chamber cavity; a first valve bore formed in the valving body and open through the second body end; a second valve bore formed in the valving body and open through the second body end; and a valve assembly supported by the valving body. The valve assembly includes a first valve member at least partially disposed within the first valve bore; and a second valve member at least partially disposed within the second valve bore. The first valve member is movable relative to the first valve bore between a first member first state, in which flow of the first constituent material to the mix chamber cavity is blocked such that the first constituent material is prevented from flowing to the mix chamber cavity, and a first member second state, in which flow of the first constituent material to the mix chamber cavity is unblocked such that the first constituent material is able to flow to the mix chamber cavity. The second valve member is movable relative to the second valve bore between a second member first state, in which flow of the second constituent material to the mix chamber cavity is blocked such that the second constituent material is prevented from flowing to the mix chamber cavity, and a second member second state, in which flow of the second constituent material to the mix chamber cavity is unblocked such that the second constituent material is able to flow to the mix chamber cavity.

According to yet another additional or alternative aspect of the disclosure, a plural component sprayer configured to receive a first constituent material and a second constituent material and emit a spray of a plural component material formed by combining the first constituent material and the second constituent material includes a gun body; a displacer disposed at least partially within the gun body; a mix chamber configured to receive the first constituent material and the second constituent material and emit the plural component material; a first flow valve configured to control flow of the first constituent material to the mix chamber; a second flow valve configured to control flow of the second constituent material to the mix chamber; and a shutoff supported by the gun body and connected to the first flow valve and the second flow valve, the shutoff configured to actuate the first flow valve to shut off the flow of the first constituent material to the mix chamber and configured to actuate the second flow valve to shut off the flow of the second constituent material to the mix chamber.

According to yet another additional or alternative aspect of the disclosure, a plural component sprayer configured to receive a first constituent material and a second constituent material and emit a spray of a plural component material formed by combining the first constituent material and the second constituent material includes a gun body; a displacer disposed at least partially within the gun body; a mix chamber configured to receive the first constituent material and the second constituent material and emit the plural component material, the mix chamber configured to emit the plural component material from a spray orifice and in a first axial direction along a spray axis; a valve assembly configured to control flow of the first constituent material to the mix chamber and control flow of the second constituent material to the mix chamber, the valve assembly connected to the displacer to be actuated along the spray axis; and a shutoff connected to the valve assembly and configured to actuate the valve assembly in a second axial direction along the spray axis opposite the first axial direction to shut off the flow of the first constituent material and the flow of the second constituent material to the mix chamber.

### BRIEF DESCRIPTION OF THE DRAWINGS

FIG. 1A is a first isometric view of a sprayer.

FIG. 1B is a second isometric view of a sprayer.

FIG. 1C is an exploded view of a sprayer.

FIG. 2A is a cross-sectional view taken along line 2-2 in FIG. 1A showing the sprayer in a non-spray state.

FIG. 2B is a cross-sectional view taken along line 2-2 in FIG. 1A showing the sprayer in a spray state.

FIG. 3 is a cross-sectional view taken along line 3-3 in FIG. 1A.

FIG. 4A is an enlarged view of detail 4A in FIG. 3.

FIG. 4B is a cross-sectional view taken along line 4B-4B in FIG. 3 showing an interface between a cartridge and a manifold.

FIG. 5A is an isometric view of a cartridge and mix assembly.

FIG. 5B is an exploded view of the cartridge and mix assembly.

FIG. 5C is an isometric view of a cartridge.

FIG. 6A is a cross-sectional view taken along line A-A in FIG. 5A.

FIG. 6B is a cross-sectional view taken along line B-B in FIG. 5A.

FIG. 6C is a cross-sectional view taken along line C-C in FIG. 5A.

FIG. 7A is a cross-sectional view taken along line 7-7 in FIG. 5A showing a valve assembly in a position associated with the flow valves being in respective first open states.

FIG. 7B is a cross-sectional view taken along line 7-7 in FIG. 5A showing a valve assembly in a position associated with the flow valves being in respective closed states.

FIG. 7C is a cross-sectional view taken along line 7-7 in FIG. 5A showing valve assembly in a position associated with the flow valves being in respective second open states.

FIG. 8A is an isometric view of a cartridge from a rear side of the cartridge.

FIG. 8B is an enlarged isometric view of the cartridge from a rear side of the cartridge with the gas stem removed for clarity.

FIG. 8C is an enlarged isometric view of a portion of an actuator assembly.

FIG. 9 is an exploded view of a valve assembly showing the interface between valve members and a coupler.

FIG. 10A is an isometric view of a coupler.

FIG. 10B is an elevation view of a rear side of the coupler.

FIG. 11A is a partial cross-sectional view taken along line 11-11 in FIG. 1A showing the shutoff in an unlocked state.

FIG. 11B is a partial cross-sectional view similar to FIG. 11A but showing the shutoff in a locked state.

FIG. 12A is a first exploded view of the shutoff and drive piston.

FIG. 12B is a second exploded view of the shutoff and drive piston.

FIG. 13A is an isometric view of the shutoff and drive piston showing the shutoff in an unlocked state.

FIG. 13B is an isometric view of the shutoff and drive piston showing the shutoff in a locked state.

### DETAILED DESCRIPTION

The present disclosure relates generally to plural component sprayers. A cartridge of the present disclosure provides quick and efficient assembly of a spray gun for spraying and disassembly for maintenance. The cartridge is mountable to and dismountable from an actuator assembly of the spray gun as a single unit. The cartridge contains the valving components that control flow of constituent materials to a mix chamber for combination into the plural component material and for spraying. The valving components can control flows of constituent materials and flows of compressed air to the mix chamber.

Cartridges according to the present disclosure can include a mix chamber that is at least partially disposed within and supported by a cartridge body of the cartridge. The mix chamber is mountable to the cartridge body such that the mix chamber can remain mounted to the cartridge body as the cartridge is mounted to and dismounted from the spray gun. Removal of the cartridge from the actuator assembly of the spray gun can necessarily dismount the mix chamber from the other components of the spray gun.

Cartridges according to the present disclosure are mountable to the spray gun at a dynamic connection interface. The dynamic interface conveys mechanical force to the valves of the cartridge to actuate the valves between various flow states. The cartridge includes a valve coupling that is configured to receive the mechanical forces from the actuator assembly of the spray gun and convey the mechanical forces to the valving components to actuate the valving components.

Cartridge according to the present disclosure are mountable to the spray gun at a static connection interface. The static interface fixes the cartridge to the gun body of the spray gun. The static interface prevents relative movement of the cartridge along a spray axis to maintain the cartridge mounted on the gun body. A body coupling of the cartridge interfaces with the gun body to mount the cartridge to the gun body. The body coupling of the static interface and the valve coupling of the dynamic interface can be configured to mount to the spray gun such that the dynamic connection interface and the static connection interface are simultaneously formed during mounting and simultaneously broken during dismounting.

Spray guns according to the present disclosure include a manual shutoff that allows the user to manually actuate the valving components of the cartridge to shut off the flows of the constituent materials. The shutoff actuates the valving components of the cartridge to block flow of the constituent materials to the mix chamber, thereby stopping spraying of the plural component material. The shutoff can be configured to lock the spray gun into a non-spray state such that the spray gun cannot be actuated to a spray state even if the trigger is depressed.

Components can be considered to radially overlap when those components are disposed at common axial locations along an axis. A radial line extending from the axis will extend through each of the radially overlapping components. Components can be considered to axially overlap when those components are disposed at common radial and circumferential locations relative to an axis such that an axial line parallel to the axis extends through the axially overlapping components. Components can be considered to circumferentially overlap when aligned about the axis, such that a circle centered on the axis passes through the circumferentially overlapping components.

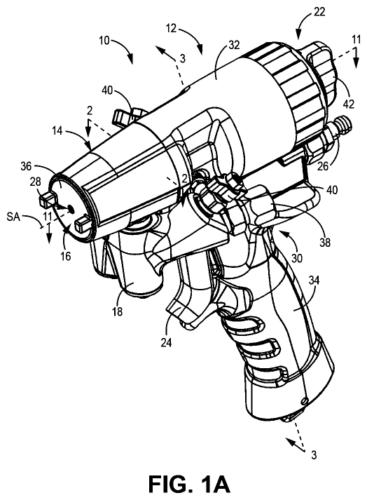

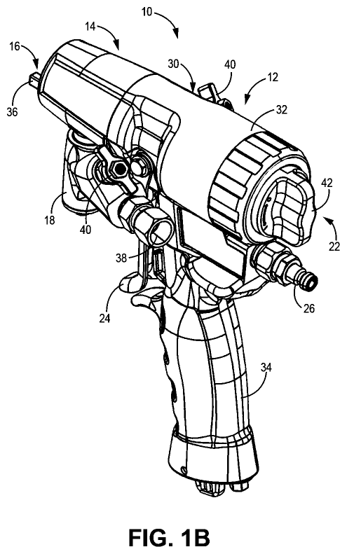

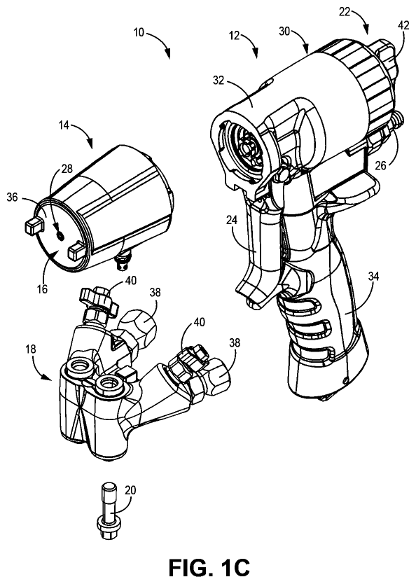

FIG. 1A is a first isometric view of sprayer 10. FIG. 1B is a second isometric view of sprayer 10. FIG. 1C is an exploded view of sprayer 10. FIGS. 1A-1C are discussed together. Sprayer 10 includes actuator assembly 12, gun body 30 cartridge 14, mix assembly 16, manifold 18, fastener 20, shutoff 22, trigger 24, gas fitting 26, and spray orifice 28. Gun body 30 of actuator assembly 12 is shown. Gun body 30 includes housing 32 and handle 34. Air cap 36 of mix assembly 16 is shown.

Sprayer 10 is configured as a plural component sprayer. Sprayer 10 is configured to receive flows of individual constituent materials and combine those constituent materials into a plural component material that is output from the sprayer 10 as a spray. Sprayer 10 is configured to receive individual flows of the constituent materials, such as two or more constituent materials, to combine the constituent materials to form the plural component material, and to emit a spray of the resultant plural component material. Sprayer 10 can also be referred to as a spray gun.

In some examples, sprayer 10 can be configured as a foam spray gun that can spray various foams such as polyurea and other multi-part foam fluids that cure or otherwise set in place. Typical foam spray system includes a first pump and a second pump (not shown). The first pump supplies a first constituent material and the second pump supplies a second constituent material. The plural component spray foam is typically created by mixing the first constituent material (e.g., isocyanate) and the second constituent material (e.g., polyol resin) to form the resultant foam. While sprayer 10 is described as a foam spray gun, it is understood that foam is one broad type of sprayable plural component materials. Plural component materials can also be glues, adhesives, coatings, epoxies, and other materials. While spray foam will be used as an example, the constituent materials can be any type of component liquids that can be mixed and sprayed. The mixtures are combined in the sprayer 10 and sprayed as a single solution.

The terms component A and component B will be used herein to refer to liquids that can be mixed and then sprayed as a single fluid. While spray foam will be used as an example, the component A and the component B can be any type of component liquids that can be mixed and sprayed. The mixtures are combined in the sprayer 10 and sprayed as a single solution. The single solution can be referred to as the plural component material as it is formed from the multiple constituent components (e.g., component A and component B). While component A and component B are used herein for purposes of example, it is understood that some plural component materials can be formed from more than two constituent materials and that the disclosure herein is not limited to plural component materials formed from two constituent components.

The constituent components are typically mixed in sprayer 10 and then sprayed in a matter of milliseconds due to the quick reacting and setting nature of the fluids. Mixing can occur within a mix chamber within the sprayer 10. The mix chamber can form part of the nozzle of the sprayer 10 in various embodiments. Spray orifice 28 can be formed by the mix chamber. The mix chamber can be connected to air cap 36 and form a component of the mix assembly 16, as discussed in more detail below

Actuator assembly 12 is configured to support cartridge 14 and is configured to actuate valves within cartridge 14 between various flow states. Actuator assembly 12 can actuate the valves of cartridge 14 to start and stop spraying of the plural component material by sprayer 10. Actuator assembly 12 may include an outer housing (e.g., formed by gun body 30) and various internal components. Actuator assembly 12 includes a displacer that provides force to the valves of the cartridge 14 to actuate the valves of the cartridge 14 and control flows of the constituent materials to the mix chamber.

Gun body 30, which can also be referred to as an air body, supports other components of sprayer 10. Handle 34 extends from housing 32. Gun body 30 is configured to receive flows of compressed gas, such as compressed atmospheric air, and to route the compressed gas to other components of sprayer 10. Gas fitting 26 extends from gun body 30 and is configured to connect to a hose extending from a compressed gas source (e.g., pressurized tank, compressor, etc.). The hose provides the compressed gas to the sprayer 10 at gas fitting 26. The gas fitting 26 can be configured to connect to the hose in any desired manner. For example, gas fitting 26 can be configured as a quick-connect style fitting, can include exterior threading, etc.

Housing 32 contains an actuator, such as a piston, configured to actuate the valving components of cartridge 14 to control flow of the constituent materials to the spray orifice 28. Gun body 30 is configured to route the compressed gas to chambers within housing 32 to displace the actuator and is configured to route compressed gas to cartridge 14. Cartridge 14 routes the compressed gas to the mix assembly 16 for output from air cap 36 and from spray orifice 28.

Handle 34 can be used for gripping the sprayer 10 by a single hand such that the sprayer 10 can be picked up, supported, and operated with a single hand of a user. The sprayer 10 includes a trigger 24 that is supported by gun body 30. Actuation of the trigger 24 by one or multiple fingers of the user may cause spraying from the sprayer 10 and release of the trigger 24 may cease spraying from the sprayer 10.

Cartridge 14 is configured to mount to gun body 30. Cartridge 14 is mountable to gun body 30 and dismountable from gun body 30. Cartridge 14 is mountable and dismountable as a single module. No flowpaths of the first constituent material and the second constituent material remain mounted on or disposed within the actuator assembly when the cartridge is dismounted. Cartridge 14 includes internal valving components that are configured to control the constituent material flows to the mix assembly 16. The internal valving components can be configured to control at least a portion of the flow of the compressed gas to the mix assembly 16. In the example shown, cartridge 14 is configured to directly interface with housing 32 to mount to gun body 30. Cartridge 14 contains fluid-handling components. Cartridge 14 is configured to route the constituent materials and the compressed gas to the mix assembly 16.

Manifold 18 is supported by gun body 30. In the example shown, manifold 18 is mounted to cartridge 14 and is supported by gun body 30 via cartridge 14. The constituent materials are supplied to the cartridge 14 via manifold 18. In various other embodiments, the constituent materials may be introduced via channels through the gun body 30. However, in the illustrated embodiment, and in various embodiments, the constituent materials do not flow through the gun body 30 but instead directly flow to the cartridge 14 via manifold 18. In the example shown, the gun body 30 does not route flows of the constituent materials and the constituent materials do not flow within the gun body 30.

The manifold 18 attaches to the cartridge 14 directly. The manifold 18 does not attached to the gun body 30. As shown, the manifold 18 mounts to the cartridge 14 via fastener 20. In the example shown, the fastener 20 is formed as a threaded bolt, although different types of connections are possible. Fastener 20 extends through a portion of manifold 18 and into cartridge 14, in the example shown.

Manifold 18 is configured to connect to component lines that provide the individual flows of the constituent materials to manifold 18. Manifold 18 includes material inlets 38 that receive the constituent materials into manifold 18. The material inlets 38 can be formed as fittings configured to connect to component lines (e.g., hoses) that supply constituent material to manifold 18. The material inlets 38 can be formed of any desired configuration for connecting with a supply line, such a quick-connect, threaded, etc. Manifold 18 routes the constituent materials to cartridge 14. The constituent materials are maintained in fluidly separate, distinct paths within manifold 18. The constituent materials do not mix within manifold 18. The constituent materials are provided to cartridge 14 as distinct, separate flows.

Manifold 18 includes materials valves 40 that are actuatable between open and closed states. The materials valves 40 can be actuated by the user by accessing a handle of the material valve 40 from the exterior of manifold 18. With a material valve 40 in the closed state, the flowpath through manifold 18 is closed and the constituent material associated with that material valve 40 is prevented from flowing downstream to cartridge 14. With the material valve 40 in the open state, the flowpath through manifold 18 is open and the constituent material associated with that material valve 40 is able to flow to cartridge 14.

Mix assembly 16 is mountable to and dismountable from cartridge 14. Air cap 36 is configured to output compressed gas proximate spray orifice 28. Spray orifice 28 is oriented through a central opening in air cap 36. Spray orifice 28 is oriented along spray axis SA along which sprayer 10 is configured to output the plural component material. Spray orifice 28 is configured to emit a spray of the plural component material from sprayer 10. During spraying, the fluid mixture is emitted from the spray orifice 28. In various examples, the spray orifice 28 is supported at least in part by air cap 36. The air cap 36 can be a retainer for a mix chamber, as discussed in more detail below. The spray orifice 28 can be formed by the mix chamber.

Shutoff 22 is supported by gun body 30. Knob 42 of shutoff 22 is accessible on an exterior of sprayer 10. Shutoff 22 is actuatable between a locked state and an unlocked state. With shutoff 22 in the locked state, the sprayer 10 is locked in the non-spray state such that the valving components within cartridge 14 cannot be actuated to open the flowpaths for the constituent materials to flow to mix assembly 16. With shutoff in the unlocked state, the sprayer 10 can be placed in the spray state, such as by actuating trigger 24, such that the valving components within cartridge 14 can be actuated to open the flowpaths for the constituent materials to flow to mix assembly 16. In the example shown, knob 42 provides a user interface of the shutoff 22. The knob 42 can be actuated by the user to shift the shutoff 22 between the locked and unlocked states. For example, the user can rotate knob 42 to shift the shutoff 22 between the locked and unlocked states.

Shutoff 22 can be configured to actuate the sprayer 10 to the non-spray state from the spray state. For example, if the compressed gas supply to sprayer 10 is lost during operation while sprayer 10 is in the spray state, then shutoff 22 can be actuated to the locked state, which displaces the valving components of cartridge 14 and places the sprayer 10 in the non-spray state. Shutoff 22 can be actuated from the unlocked state to the locked state regardless of the operating state of the sprayer 10. The shutoff 22 actuating the sprayer 10 to the non-spray state can shut off spraying of the plural component material even when motive power to the actuator that displaces the valving components of cartridge 14 is lost, providing a manual shutoff for such a situation.

During operation, sprayer 10 is assembled by connecting cartridge 14 to actuator assembly 12. Manifold 18 is mounted to cartridge 14 by fastener 20. Mix assembly 16 is mounted to cartridge 14. It is understood that mix assembly 16 can be mounted to cartridge 14 prior to cartridge 14 being mounted to actuator assembly 12 or after cartridge 14 is mounted to actuator assembly 12. Compressed gas is provide to sprayer 10 and enters into gun body 30 at gas fitting 26. Constituent materials are pumped to manifold 18 and enter into manifold at material inlets 38. The materials valves 40 are placed in open states such that the constituent materials can flow to cartridge 14.

With shutoff 22 in the unlocked state, the user actuating trigger 24 causes the valving components of cartridge 14 to shift to allow the constituent materials to flow to mix assembly 16. For example, the compressed gas can displace the actuator within housing 32 to displace the valving components. The constituent materials flow to the mix chamber and combine within the mix chamber to form the plural component material. The plural component material is emitted as a spray through spray orifice 28.

The user releases trigger 24 to stop spraying by sprayer 10. The user releasing trigger 24 can cause the compressed gas to be redirected within gun body 30 to displace the actuator in an opposite direction. The actuator displaces the valving components of cartridge 14 to shut off the flows of the constituent materials to the mix assembly 16. The spray of plural component material through spray orifice 28 is stopped.

Sprayer 10 provides significant advantages. Cartridge 14 receives flows of the constituent materials from manifold 18 and flows of compressed gas from gun body 30. The gun body 30 does not handle the constituent materials. The constituent materials do not flow within gun body 30. The gun body 30 does not include any pathways fluidly connected to pathways of the plural component material. Isolating the gun body 30 from the constituent materials prevents any inadvertent mixing within the gun body 30 and reduces the number of components that require cleaning of the constituent materials after spraying. The gun body 30 is protected from and isolated from the constituent materials such that operation of gun body 30 is preserved even if undesired curing occurs in any of the material pathways through sprayer 10.

Cartridge 14 routes both the constituent materials and the compressed gas to the mix assembly 16. The cartridge 14 is mountable to and dismountable from the gun body 30 as a single unit. The cartridge 14 can be removed from gun body 30 and replaced with a new cartridge 14 in the event that undesired curing occurs in the material passages of cartridge 14. Cartridge 14 isolating the constituent materials from gun body 30 protects the gun body 30 and isolates any cross-over between the constituent materials, which can lead to the undesired curing, within the cartridge 14. The cartridge 14 can be removed and replaced without servicing other components of sprayer 10.

Cartridge 14 includes the valving components that control flow of the constituent materials to the mix assembly 16. The valving components, including movable and static portions of the valving components, form portions of the cartridge 14 that mount to actuator assembly 12 with cartridge 14 and dismount from actuator assembly 12 with cartridge 14. The valving components being integrated into cartridge 14 facilitates mounting and removal of the constituent-handling components of sprayer 10.

Manifold 18 is connected to cartridge 14. Manifold 18 does not have any flowpaths fluidly connected to the gun body 30. Manifold 18 routes only constituent materials to cartridge 14. The constituent materials do not mix within manifold 18 and manifold 18 does not include any fluid connection between the pathways of the constituent materials. Sprayer 10 includes gun body 30 that routes compressed gas, manifold 18 that routes constituent materials, and cartridge 14 that routes the constituent materials for combination at mix assembly 16 that is supported by cartridge 14 and routes compressed gas for emission from sprayer 10. The cartridge 14 being mountable and dismountable as a single unit allows for quick and easy assembly and disassembly of sprayer 10. Cartridge 14 being mountable as the single unit decreases part count and decreases the complexity and time required to disassemble and assemble valving components, as the valving components are part of cartridge 14.

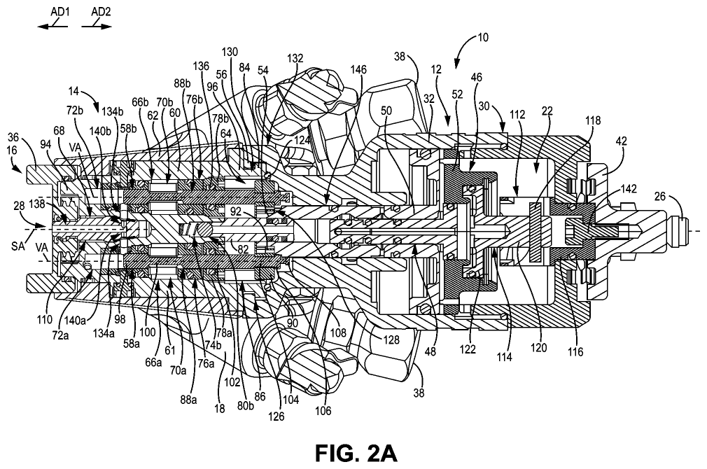

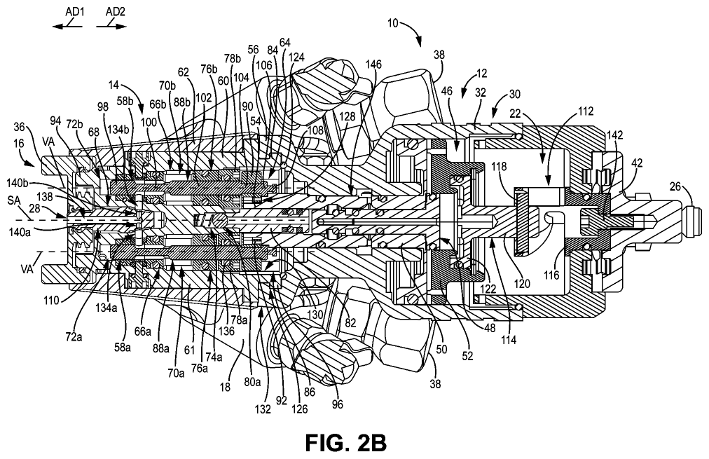

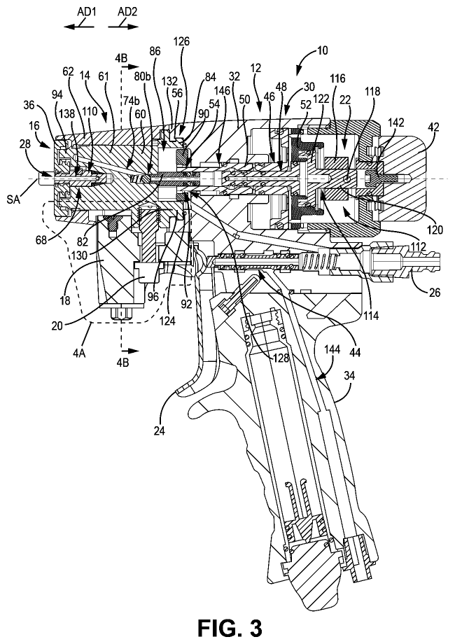

FIG. 2A is a cross-sectional view taken along line 2-2 in FIG. 1A showing sprayer 10 in a non-spray state. FIG. 2B is a cross-sectional view taken along line 2-2 in FIG. 1A showing sprayer 10 in a spray state. FIG. 3 is a cross-sectional view taken along line 3-3 in FIG. 1A. FIGS. 2A-3 are discussed together and with continued reference to FIGS. 1A-1C.

Sprayer 10 includes actuator assembly 12, cartridge 14, mix assembly 16, manifold 18, fastener 20, shutoff 22, trigger 24, gas fitting 26, spray orifice 28, gas valve 44, drive piston 46, and dose piston 48. Actuator assembly 12 includes gun body 30 and dose piston 48. Drive piston 46 includes piston shaft 50, piston head 52, and drive mount 54. Gun body 30 includes housing 32 and handle 34. Housing 32 includes housing mount 56. Flow valves 58a, 58b; valving body 60; outer body 62; valve assembly 64; valve bores 66a, 66b; mix chamber cavity 68; flow chambers 70a, 70b; gas chambers 72a, 72b; gas channel 74b; seal bodies 76a, 76b; retainers 78a, 78b; gas check 80b; gas stem 82; and body mount 84 of cartridge 14 are shown. Valve assembly 64 includes valve members 88a, 88b; coupler 90; and valve mount 92. Each valve member 88a, 88b includes a flow head 98, flow neck 100, member body 102, mount neck 104, mount head 106, and tail 108. Mix assembly 16 includes air cap 36 and mix chamber 110. Shutoff 22 includes knob 42, converter 112, and connector 114. Converter 112 includes converter body 116 and positioner 118. Connector 114 includes connector head 122 and connector shaft 120.

Sprayer 10 is configured to receive individual flows of constituent materials, mix the constituent materials to form a plural component material, and emit the resultant plural component material through spray orifice 28. The sprayer 10 sprays along a spray axis SA. The axis also represents an upstream side or direction and a downstream side or direction, wherein the constituent materials generally flow from the upstream direction towards the downstream direction. In the example shown, first axial direction AD1 is generally the downstream direction while second axial direction AD2 is generally the upstream direction with regard to spray axis SA. The mix chamber 110, including the spray orifice 28, is coaxial with the axis SA.

Actuator assembly 12 is configured to support cartridge 14 and to actuate flow valves 58a, 58b of cartridge 14 between various states. Actuator assembly 12 is configured to support cartridge by a static interface 126 between gun body 30 and valving body 60. Actuator assembly 12 is configured to actuate the valve assembly 64 of cartridge 14 via a dynamic interface 128 between valve assembly 64 and drive piston 46.

In the example shown, the static interface 126 is disposed radially outward of the dynamic interface 128. The static interface 126 can radially overlap with the dynamic interface 128, during at least some phases of operation. The relative positions of the static interface 126 and the dynamic interface 128 aligns forces and provides for efficient transfer of mechanical forces along spray axis SA to valve assembly 64. The dynamic interface 128 can move axially relative to the static interface 126 during operation.

Gun body 30 is configured to support other components of sprayer 10 during spraying. Handle 34 is a portion of gun body 30 that is configured to be grasped by a hand of a user to orient and manipulate sprayer 10. Handle 34 projects from a bottom side of housing 32. Handle 34 can be formed separately from housing and connected to housing 32, such as by one or more fasteners, such as bolts, among other options.

Housing 32 supports other components of sprayer 10. Housing 32 is configured to receive flows of compressed gas and defines flowpaths that direct those flows within sprayer 10. Compressed gas can be used for several functions including purging, actuating valves, mixing, and propelling, amongst other options. Compressed gas can be compressed air, amongst other options. Compressed gas can be formed from an inert gas, such as nitrogen gas. Gas fitting 26 is supported by housing 32. Gas fitting 26 is configured to connect to a hose or other conveyance that supplies compressed gas to sprayer 10. Gas fitting 26 can be configured to connect to the hose in any desired manner, such as by interfaced threading or in a quick-connect manner, among other options.

Gas valve 44 is disposed within gun body 30. In the example shown, gas valve 44 is disposed within housing 32. Gas valve 44 is configured to direct the compressed gas within sprayer 10. Gas valve 44 is configured to be actuated by trigger 24 to route the compressed gas to cause actuation of the sprayer 10 between spray and non-spray states. For example, gas valve 44 can route compressed gas to a first axial side of drive piston 46 to displace drive piston 46 in first axial direction AD1 when trigger 24 is depressed to place sprayer 10 in the spray state. Gas valve 44 can route the compressed gas to a second axial side of drive piston 46 to displace drive piston 46 in second axial direction AD2 when trigger 24 is released to place sprayer 10 in the non-spray state.

Trigger 24 is supported by gun body 30. Trigger 24 is disposed in front of handle 34 such that a person grasping handle 34 can actuate trigger 24 with the fingers of the hand grasping handle 34. Trigger 24 is positioned such that a front surface of the trigger 24 is accessible by the fingers of the user to actuate trigger 24. Actuation of the trigger 24 can actuate gas valve 44 within the gun body 30 to route and/or block compressed gas within the sprayer 10 to open and/or close valves.

Drive piston 46 is supported by gun body 30. Drive piston 46 is disposed within housing 32. Piston head 52 divides a piston chamber within housing 32 into fluidly separated drive chambers. Compressed gas is provided to a first one of the drive chambers to displace drive piston 46 in first axial direction AD1. Compressed gas is provided to a second one of the drive chambers to displace drive piston 46 in second axial direction AD2. Drive piston 46 can be considered to form the displacer of actuator assembly 12.

Piston shaft 50 extends in first axial direction AD1 from piston head 52. Piston shaft 50 extends axially through gun body 30 and is configured to interface with cartridge 14 at dynamic interface 128. In the example shown, piston shaft 50 projects out of a shaft bore formed in housing 32 to form the dynamic interface 128 with cartridge 14. The drive piston 46 conveys mechanical motion to the valve assembly 64 at the dynamic interface 128 to open and close the material flowpaths through cartridge 14. The drive piston 46 is disposed coaxially with the mix chamber 110 on spray axis SA in the example shown.

Dose piston 48 is disposed within drive piston 46. Dose piston 48 is configured to dose solvent into a flow of compressed gas that is provided to cartridge 14 from gun body 30. The compressed gas provided through dose piston 48 and drive piston 46 can be referred to as B-side gas that is provided to the component flowpaths associated with the B-side constituent material. Dose piston 48 is movable relative to the drive piston 46 in the example shown. Dose piston 48 can be configured to dose solvent into the B-side gas.

Cartridge 14 is mounted to gun body 30. As further explained herein, the cartridge 14 is removable from the gun body 30 as a unitary body for quick replacement of valving that controls flows of constituent material and, in some example, compressed gas to mix chamber 110. Cartridge 14 is mounted to gun body 30 by static interface 126 between cartridge 14 and gun body 30. The static interface 126 does not include moving parts. The static interface 126 supports cartridge 14 on gun body 30. In the example shown, the static interface 126 is formed between cartridge 14 and housing 32. More specifically, the static interface 126 is formed between valving body 60 and housing 32. In the example shown, the static interface 126 is formed between a projection and a receiver that the projection extends into. In the example shown, the projection 130 is formed by cartridge 14 and the receiver 132 is formed by gun body 30.

In the example shown, the static interface 126 forms a pneumatic connection between the cartridge 14 and the actuator assembly 12 in which compressed gas routed through the spray gun body 30 is further routed into the valving body 60.

Cartridge seal 124 is disposed between and engages with cartridge 14 and gun body 30. In the example shown, cartridge seal 124 engages with and seals against valving body 60 and housing 32. Cartridge seal 124 can be an O-ring or gasket, amongst other options. Cartridge seal 124 is located within the receiver 132. Cartridge seal 124 can interface with the projection 130 to allow the transfer of pressurized gas from the gun body 30 to the cartridge 14 for purge air. While cartridge seal 124 is shown as supported by gun body 30 such that cartridge 14 moves into or out of engagement with cartridge seal 124 during mounting and dismounting, it is understood that alternatively the cartridge seal 124 can be located on the cartridge 14 to mount and dismount with cartridge 14. For example, the cartridge seal 124 can be disposed on and supported by valving body 60.

Valving body 60 defines flowpaths for constituent materials and compressed gas. Valving body 60 extends between first body end 94 and second body end 96. Valving body 60 extends along spray axis SA between first body end 94 and second body end 96. First body end 94 is oriented in first axial direction AD1. First body end 94 can be considered to form a downstream end of cartridge 14. Second body end 96 is oriented in second axial direction AD2. Second body end 96 can be considered to form an upstream end of cartridge 14. Cartridge 14 is configured such that first body end 94 is a spray output end of valving body 60 from which spray (e.g., plural component material, compressed gas) is emitted from cartridge 14. Cartridge 14 is configured such that connections with actuator assembly 12 (e.g., the driving connection at dynamic interface 128 and the support connection at static interface 126) are formed at second body end 96. In the example shown, valving body 60 does not receive constituent materials through second body end 96. In the example shown, valving body 60 does receive compressed gas at second body end 96. Valving body 60 is configured such that plural component material and compressed gas are output through first body end 94.

Body mount 84 is formed on cartridge 14. In the example shown, body mount 84 is formed on second body end 96 of valving body 60. Body mount 84 is configured to interface with housing mount 56 of gun body 30 to form the static interface 126. For example, static interface 126 can be formed as a projection-receiver interface between body mount 84 and housing mount 56, as discussed in more detail below. The static interface 126 supports cartridge 14 on gun body 30. The static interface 126 does not shift along spray axis SA during operation of sprayer 10.

Outer body 62 is supported on valving body 60. Outer body 62 forms an exterior of cartridge 14. Outer body 62 can also be referred to as a cover. In some examples, outer body 62 is formed from a polymer and valving body 60 is formed from a metal, such as aluminum among other options. In the example shown, outer body 62 is open in both first axial direction AD1 and second axial direction AD2 such that valving body 60 is exposed axially in both axial directions.

Mix chamber cavity 68 is formed in valving body 60. Mix chamber cavity 68 extends into valving body 60 from first body end 94. Mix chamber cavity 68 does not extend fully axially through valving body 60. Mix chamber cavity 68 is open in first axial direction AD1 and closed in second axial direction AD2. Mix chamber cavity 68 is open in one axial direction such that mix chamber 110 cannot pass through mix chamber cavity 68. Mix chamber cavity 68 is configured such that mix chamber 110 can pass through the single opening into the mix chamber cavity 68, the single opening oriented in first axial direction AD1. The mix chamber cavity 68 is open in the downstream direction and closed in the upstream direction such that mix chamber 110 cannot pass through the second body end 96 of valving body 60.

Mix chamber cavity 68 is open in a downstream direction and closed in an upstream side of cartridge 14. Mix chamber 110 can be inserted into mix chamber cavity 68 from the downstream direction and removed from the downstream direction but cannot be moved through the upstream direction of cartridge 14 and valving body 60.

Mix assembly 16 is mountable to cartridge 14 to be supported by cartridge 14. In the example shown, mix assembly 16 is mounted to valving body 60. Mix assembly 16 is mounted to first body end 94 of valving body 60 in the example shown. Air cap 36 is configured to route compressed gas about the spray orifice 28, such as to clean the spray orifice 28. Air cap 36 can be mounted to mix chamber 110 such that air cap 36 and mix chamber 110 are connected together as a single assembly. For example, mix chamber 110 can include exterior threading and air cap 36 can include interior threading such that air cap 36 can be threaded onto mix chamber 110. The mix assembly 16 is configured such that a user can mount mix chamber 110 within mix chamber cavity 68 by grasping and manipulating air cap 36 without grasping on mix chamber 110.

Air cap 36 is mounted to cartridge 14 and retains mix chamber 110 within mix chamber cavity 68. In the example shown, air cap 36 includes exterior threading that interfaces with interior threading of cartridge 14 to mount air cap 36 to valving body 60. The threaded interface between air cap 36 and valving body 60 can radially overlap with the exterior threading on mix chamber 110 with mix assembly 16 mounted to cartridge 14. Air cap 36 can receive compressed gas from cartridge 14 and emit such compressed gas about mix chamber 110, such as proximate to spray orifice 28. Such air can be referred to as a cleanoff air that is configured to clean off residue from an exterior of mix chamber 110.

The mix chamber 110 is located within mix chamber cavity 68 within the cartridge 14. More specifically in the particular embodiment shown, the mix chamber 110 is predominantly within the valving body 60 and extends partially out from the valving body 60. The mix chamber 110 can be removed from or inserted into the mix chamber cavity 68 while cartridge 14 is mounted to the gun body 30. Mix chamber 110 can also be removed from or inserted into mix chamber cavity 68 while the cartridge 14 is already dismounted from the gun body 30. Likewise, the cartridge 14 can be mounted to or dismounted from the gun body 30 with or without mix chamber 110 mounted to cartridge 14. Alternatively the mix chamber 110 may be mounted within the mix chamber cavity 68 of the cartridge 14, and the air cap 36 attached to the cartridge 14, while cartridge 14 is in the process of being mounted onto the gun body 30. Cartridge 14 supports the mix chamber 110 such that the mix chamber 110 does not contact the gun body 30 and does not extend into the gun body 30. The mix chamber 110 does not radially overlap with any portion of the gun body 30 in the example shown. The mix chamber 110 does not contact the spray gun body 30 during spraying.

Spray orifice 28 is formed at a downstream end of mix chamber 110. Spray orifice 28 is formed by mix chamber 110 in the example shown. Mix chamber 110 is configured as a stationary mix chamber 110 in the example shown in that mix chamber 110 does not shift along spray axis SA to actuate sprayer 10 between spray and non-spray states. The mix chamber 110 is configured to remain stationary as flow valves 58a, 58b are actuated to turn on and turn off flow of the constituent materials to the mix chamber 110.

Valve bores 66a, 66b extend into valving body 60. Valve bores 66a, 66b extend only partially axially through valving body 60 in the example shown. The valve bores 66a, 66b are open in second axial direction AD2 and are closed in first axial direction AD1. The valve bores 66a, 66b are open to allow valve members 88a, 88b to pass into valve bores 66a, 66b. The valve bores 66a, 66b are closed in first axial direction AD1 such that the valve members 88a, 88b cannot pass fully axially through valve bores 66a, 66b.

Each valve bore 66a, 66b extends along a valve axis VA. In the example shown, the valve axis VA is parallel with and radially offset from the spray axis SA. In some examples, a plane can be disposed through cartridge 14 along which each of the spray axis SA and the two valve axes VA extend.

Valve bores 66a, 66b extend into valving body 60 from second body end 96 of valving body 60. Valve bores 66a, 66b defines flowpaths for constituent material and compressed gas to flow to mix chamber 110. In the example shown, each valve bore 66a, 66b is open to body chamber 86 that extends into second body end 96 of valving body 60. Valve bores 66a, 66b are radially offset from spray axis SA. Portions of the valve bores 66a, 66b extend to radially overlap with mix chamber cavity 68. Such a configuration provides for a compact cartridge 14.

Valve bore 66a, 66b respectively include flow chambers 70a, 70b. The flow chambers 70a, 70b are fluidly connected to the manifold 18 to receive a constituent material from manifold 18. Each flow chamber 70a, 70b is fluidly connected to the manifold 18 throughout operation. The flow valves 58a, 58b control flow of the constituent materials from the flow chambers 70a, 70b to the mix chamber 110. In the example shown, the flow chambers 70a, 70b are spaced in second axial direction AD2 from the mix chamber 110 with the mix assembly 16 mounted to cartridge 14. Flow chambers 70a, 70b are disposed upstream of mix chamber 110 such that the flow chambers 70a, 70b to do not radially overlap with the mix chamber 110. In the example shown, cartridge 14 is configured such that flowpaths containing constituent material within cartridge 14 do not radially overlap with the mix chamber 110 with sprayer 10 in the non-spray state.

In the example shown, valve bores 66a, 66b respectively include gas chambers 72a, 72b. The gas chambers 72a, 72b are fluidly connected to the compressed gas flows provide to sprayer 10. In some examples, one or both of the gas chambers 72a, 72b are fluidly connected to compressed gas flows to receive the compressed gas throughout operation of sprayer 10, both with the sprayer 10 in the spray state and with sprayer 10 in the non-spray state. In some examples, one, but not the other, of gas chambers 72a, 72b is fluidly connected to receive compressed gas throughout operation and the other gas chamber 72a, 72b is configured to receive compressed gas flow when sprayer 10 is in the non-spray state. Within each valve bore 66a, 66b, the flow chamber 70a, 70b and the gas chamber 72a, 72b of that valve bore 66a, 66b are fluidly isolated from each other by a respective valve member 88a, 88b. Valve members 88a, 88b are actuatable to fluidly connect gas chambers 72a, 72b to mix chamber 110 with sprayer 10 in the non-spray state and to fluidly connect flow chambers 70a, 70b to mix chamber 110 with sprayer 10 in the spray state.

Feed channels 134a, 134b are formed within valving body 60. Feed channels 134a, 134b extend between and fluidly connect valve bores 66a, 66b, respectively, with mix chamber cavity 68. Constituent materials and compressed gas flow through feed channels 134a, 134b and to mix chamber 110 to enter into mix chamber 110. Feed channels 134a, 134b extend radially outward relative to the spray axis SA in the example shown. It is understood, however, that not all examples are so limited. For example, feed channels 134a, 134b can extend both axially and radially, such that feed channels 134a, 134b extend transverse, but not orthogonal, to the spray axis SA.

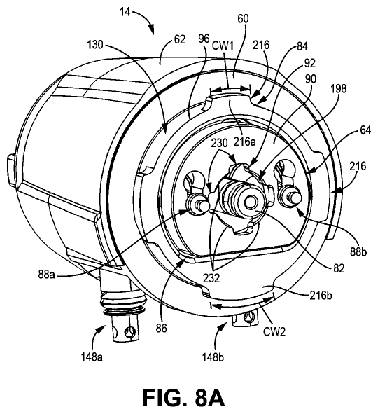

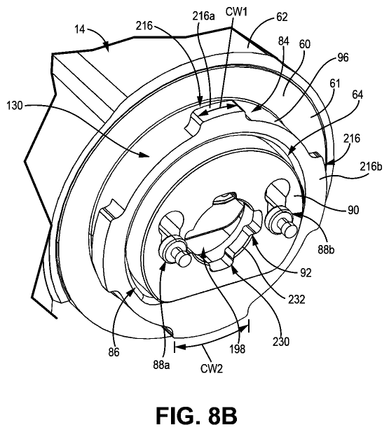

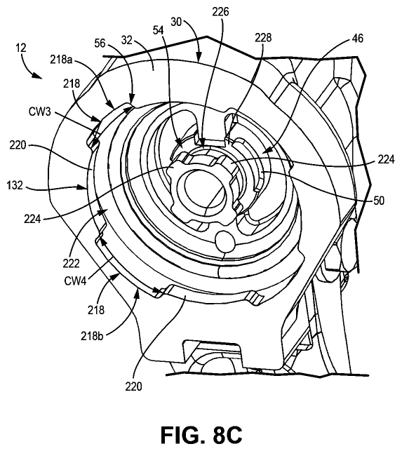

Gas channels 74a, 74b (gas channel 74b shown in FIGS. 3, 7A-8A and 8C and gas channel 74a shown in FIGS. 8B and 8C) extend within valving body 60. Gas channels 74a, 74b are configured to route compressed gas to gas chambers 72a, 72b, respectively. Gas channel 74a is fluidly connected to valve bore 66a and gas channel 74b is fluidly connected to valve bore 66b. Gas channel 74b is fluidly connected to gas chamber 72b. At least a portion of gas channel 74b is disposed coaxially with spray axis SA in the example shown. Gas channel 74b does not extend fully axially through valving body 60 in the example shown.

Gas check 80b is configured to prevent retrograde flow through gas channel 74b. Gas check 80b is configured to allow compressed gas flow in the downstream direction and to prevent retrograde flow in the upstream direction. For example, if constituent materials were to leak into the gas channels of cartridge 14or cross-over through mix chamber 110 and expansive curing occurs, the gas check 80b will prevent retrograde flow into air passages in actuator assembly 12, thereby protecting actuator assembly 12 from undesirable contamination by the constituent materials.

Gas stem 82 extends between and fluidly connects cartridge 14 and gun body 30. Gas stem 82 is configured to route compressed gas to gas channel 74b in the example shown. Gas stem 82 includes a bore extending fully axially therethrough that is configured to route compressed gas to block body 61. In the example shown, gas stem 82 is formed as a static component that does not shift along spray axis SA during operation. In the example shown, gas stem 82 is mounted to valving body 60, extends axially into drive piston 46, and interfaces with drive piston 46 at a sliding interface. The sliding interface of gas stem 82 is a telescoping interface as drive piston 46 moves relative to gas stem 82. Gas stem 82 extends fully axially through the body chamber 86 to connect gas channel 74b and a compressed gas flowpath through drive piston 46. As discussed in more detail below, gas flows to the gas channels 74a, 74b are maintained fluidly separated within cartridge 14, such as to facilitate introduction of solvent to mix chamber 110 by way of only one of the compressed gas flows.

While gas stem 82 is shown as supported by valving body 60, it is understood that not all examples are so limited. For example, gas stem 82 can be connected to drive piston 46 and extend into valving body 60. In such an example, the gas stem 82 can move with the drive piston 46 along the spray axis SA and relative to valving body 60. The gas stem 82 can telescope relative to the static valving body 60 in such an example. The gas check 80b can be disposed within drive piston 46 in such an example.

Body chamber 86 is formed within valving body 60. Body chamber 86 is open in second axial direction AD2. Each of valve bores 66a, 66b open into body chamber 86. The coupler 90 of valve assembly 64 is at least partially disposed in body chamber 86. Body chamber 86 provides an open volume for coupler 90 to reciprocate along spray axis SA, as discussed in more detail below.

Seal bodies 76a, 76b are disposed in valve bores 66a, 66b, respectively. Each seal body 76a, 76b is mounted within a respective valve bore 66a, 66b. The seal bodies 76a, 76b are configured to interface with valve members 88a, 88b, respectively, to open and close the flowpaths for the compressed gas and constituent materials to flow to mix chamber 110. In the example shown, each seal body 76a, 76b is formed as multiple components that are mounted within the valve bore 66a, 66b. It is understood, however, that not all examples are so limited. For example, the seal body 76a, 76b can be formed monolithically, among other options.

Seal bodies 76a, 76b can form the seats of the flow valves 58a, 58b that the movable component of the flow valves 58a, 58b (e.g., valve members 88a, 88b) move relative to, to open and close flowpaths through the flow valves 58a, 58b. In the example shown, each seal body 76a, 76b can be considered to form a material seat that a valve member 88a, 88b interfaces with to shut off constituent material flow and that the valve member 88a, 88b is disengaged from to allow constituent material flow to mix chamber 110. Each seal body 76a, 76b can further be considered to form a gas seat that a valve member 88a, 88b interfaces with to shut off compressed gas flow and that the valve member 88a, 88b is disengaged from to allow compressed gas flow to mix chamber 110.

Retainers 78a, 78b are mounted to valving body 60. Retainers 78a, 78b are mounted at valve bores 66a, 66b, respectively. For example, each retainer 78a, 78b can mount to valving body 60 by a threaded interface, among other options. Retainers 78a, 78b are configured to retain seal bodies 76a, 76b within valve bores 66a, 66b, respectively.

Shaft seals 136 are supported by retainers 78a, 78b. The shaft seal 136 is configured to engage with an exterior surface of a valve member 88a, 88b to seal with that exterior surface of the valve member 88a, 88b. The shaft seal 136 interfaces with the valve member 88a, 88b at a dynamic sealing interface as the valve member 88a, 88b moves relative to the shaft seal 136 during operation. The shaft seal 136 can be considered to form a sliding seal due to the sliding interface between shaft seal 136 and valve member 88a, 88b. Shaft seals 136 engage with valve members 88a, 88b to prevent the constituent materials from leaking out of valve bores 66a, 66b in second axial direction AD2.

Valve assembly 64 is configured to control flow of the constituent materials and compressed gas to mix chamber 110. Valve assembly 64 is connected to drive piston 46 at dynamic interface 128. Drive piston 46 is configured to displace valve assembly 64 axially along spray axis SA to shift sprayer 10 between the non-spray state and the spray state. Valve assembly 64 is configured to shift along spray axis SA to actuate flow valves 58a, 58b between a first open state, a second open state, and a closed state. Valve assembly 64 is supported by valving body 60.

With flow valves 58a, 58b in the first open state (shown in FIG. 2A) the gas chambers 72a, 72b are fluidly connected to the mix chamber 110 such that compressed gas can flow to mix chamber 110 to be emitted through spray orifice 28. Such compressed gas can also be referred to as purge gas. The purge gas flows through mix chamber 110 and can blow out any residual material in mix chamber 110, preventing undesired curing within mix chamber 110. With flow valves 58a, 58b in respective first open states, the flow chambers 70a, 70b are fluidly disconnected from mix chamber 110 such that the constituent materials cannot flow to mix chamber 110.

With flow valves 58a, 58b in the second open state (shown in FIG. 2B) the gas chambers 72a, 72b are fluidly disconnected to the mix chamber 110 such that compressed gas is prevented from flowing to mix chamber 110. With flow valves 58a, 58b in the second open state, the flow chambers 70a, 70b are fluidly connected to mix chamber 110 such that the constituent materials can flow to mix chamber 110 to combine within mix bore 138 of mix chamber 110, form the plural component material, and be emitted from spray orifice 28 as a spray of the plural component material.

With flow valves 58a, 58b in the closed state, each of the gas chambers 72a, 72b and the flow chambers 70a, 70b are fluidly disconnected from the mix chamber 110. The flow valves 58a, 58b being in the closed state prevents constituent materials and compressed gas from flowing to the mix chamber 110. The flow valves 58a, 58b pass through the closed state intermediate the first open state and the second open state. The flow valves 58a, 58b move from the first open state to the closed state and then to the second open state to allow constituent material flow to the mix chamber 110. The flow valves 58a, 58b move from the second open state to the closed state and then to the first open state to shut off constituent material flow and allow compressed gas flow to the mix chamber 110. The flow valves 58a, 58b being in the closed state intermediate the first and second open states prevents cross-over flow between the flow chambers 70a, 70b and the gas chambers 72a, 72b.

Valve assembly 64 is formed by valve members 88a, 88b that are mounted to coupler 90. In the example shown, each valve member 88a, 88b is formed as a shuttle that is configured to shift axially along a valve axis VA. Valve members 88a, 88b form the moving valving components of the cartridge 14. The valve members 88a, 88b form the moving valving components of the flow valves 58a, 58b. Each valve member 88a, 88b is movable along a valve axis VA. In the example shown, the valve axis VA is radially offset from the spray axis SA and disposed parallel to the spray axis SA. Valve members 88a, 88b are movable along the valve axes VA to actuate the flow valves 58a, 58b between respective first open states, closed states, and second open states.

Movement of the valve member 88a (e.g., parallel with the spray axis SA) opens and closes the flow valve 58a. The flow valve 58a routes either component A constituent material or compressed gas through the feed channel 134a into the mix chamber 110, depending on the state of the flow valve 58a. The state of the flow valve 58a depends on whether the valve member 88a is in a first position, second position, or a third position. The valve member 88a being in the first position (FIG. 2A) is associated with the flow valve 58a being in the first open state. The valve member 88a being in the second position (FIG. 2B) is associated with the flow valve 58a being in the second open state. The valve member 88 being in the third position, which is axially between the first position and the second position, is associated with the flow valve 58a being in the closed state.

Movement of the valve member 88b (e.g., parallel with the spray axis SA) opens and closes the flow valve 58b. The flow valve 58b routes either component B constituent material or compressed gas through the feed channel 134b into the mix chamber 110, depending on the state of the flow valve 58b. The state of the flow valve 58b depends on whether the valve member 88b is in a first position, second position, or a third position. The valve member 88b being in the first position (FIG. 2A) is associated with the flow valve 58b being in the first open state. The valve member 88b being in the second position (FIG. 2B) is associated with the flow valve 58b being in the second open state. The valve member 88 being in the third position, which is axially between the first position and the second position, is associated with the flow valve 58b being in the closed state.

Each valve member 88a, 88b includes a flow head 98, flow neck 100, member body 102, mount neck 104, mount head 106, and tail 108. The flow head 98 is configured to interface with seal body 76 (e.g., either directly with the seal body 76 or with a seal supported by the seal body 76) to control flows of constituent materials and compressed gas to mix chamber 110. The flow neck 100 extends between and connects the flow head 98 and the member body 102. The flow neck 100 has a smaller diameter than the flow head 98. The smaller diameter of the flow neck 100 relative to the flow head 98 allows for the constituent materials to flow around the flow neck 100 and to the mix chamber 110 when the flow valves 58 are in the second open state.

Member body 102 extends axially between flow neck 100 and mount neck 104. Member body 102 interfaces with shaft seal 136. Member body 102 is configured to slide axially relative to shaft seal 136 and is engaged with shaft seal 136 with flow valve 58a, 58b in any of the first open state, the second open state, and the closed state. Member body 102 interfaces with flow neck 100 at a location within valving body 60 and extends axially out of a respective valve bore 66a, 66b. Member body 102 has a larger diameter than flow neck 100 in the example shown.

Mount neck 104 extends axially between member body 102 and mount head 106. Mount neck 104 extends axially through coupler 90. Mount neck 104 is configured to be disposed within a slot in coupler 90 to mount a valve member 88a, 88b to coupler 90. Mount neck 104 has a smaller diameter than member body 102 and mount head 106. The larger diameters of member body 102 and mount head 106 relative to mount neck 104 facilitate coupler 90 transmitting driving forces to valve members 88a, 88b to displace valve members 88a, 88b in either first axial direction AD1 or second axial direction AD2. The coupler 90 exerts an axial driving force on member body 102 to displace valve members 88a, 88b in first axial direction AD1. The coupler 90 exerts an axial driving force on mount head 106 to displace valve members 88a, 88b in second axial direction.

In the example shown, valve members 88a, 88b include tails 108 that extends axially from the mount heads 106. The tail 108 projects axially away from mount neck 104 and is disposed on an opposite axial side of mount head 106 from mount neck 104. Tail 108 is configured to provide a tool interface that facilitates removal of valve assembly 64 from cartridge 14, such as for cleaning or replacement. For example, with cartridge 14 dismounted from gun body 30, the tail 108 can be grasped by pliers and pulled in second axil direction AD2 to pull valve assembly 64 in second axial direction AD2 and remove valve assembly 64 from cartridge 14.

It is noted that the valve members 88a, 88b are shown as single pieces in this embodiment, but in alternative embodiments may be composed of multiple pieces fixed with respect to one another. Each valve member 88a, 88b can include a head separate from a body and/or a tail separate from the body, etc.

Each valve member 88a, 88b extends into, but not through, a valve bore 66a, 66b. The valve members 88a, 88b are configured to interface with a seal body 76a, 76b to seal flowpaths to the mix chamber 110. Flow head 98 interfaces with a portion of a seal body 76a, 76b spaced in second axial direction AD2 from the feed channel 134a, 134b with flow valves 58a, 58b in the first open state. Flow head 98 interfaces with a portion of a seal body 76a, 76b spaced in first axial direction AD1 from the feed channel 134a, 134b with flow valves 58a, 58b in the second open state. Flow head 98 interfaces with portions of seal body 76a, 76b on both axial sides of feed channel 134a, 134b with flow valves 58a, 58b in the closed state. The flow head 98 radially overlaps with and covers a feed channel 134a, 134b with flow valves 58a, 58b in the closed state.

Valve members 88a, 88b are connected to coupler 90 for simultaneous actuation along the valve axes VA. Coupler 90 is disposed at least partially within body chamber 86 and is movable relative to valving body 60. Coupler 90 is connected to drive piston 46 at dynamic interface 128. The dynamic interface 128 transmits mechanical motion from drive piston 46 to coupler 90 to cause displacement of valve members 88a, 88b to actuate flow valves 58a, 58b between various operating states.

The cartridge 14 includes valve mount 92 that attached to drive mount 54 of drive piston 46 to form the dynamic interface 128 between cartridge 14 and gun body 30. The dynamic interface 128 conveys mechanical motion to actuate flow valves 58a, 58b between the various states. The valve mount 92 as part of the dynamic interface 128 can move relative to the static interface 126 between the cartridge 14 and the gun body 30. The dynamic interface 128 is configured to shift axially along the spray axis SA during operation of the sprayer 10. In the example shown, the valve mount 92 is formed on coupler 90.

Manifold 18 is mounted to cartridge 14. In the example shown, manifold 18 is mounted to cartridge 14 such that a full weight of manifold 18 is supported by cartridge 14. The full weight of the manifold 18 is transmitted through the cartridge 14 to the gun body 30. In the example shown, fastener 20 extends through manifold 18 and into valving body 60 to mount manifold 18 to valving body 60. The fastener 20 fixes manifold 18 to valving body 60.

Shutoff 22 is supported by gun body 30. Shutoff 22 is connected to drive piston 46. Shutoff 22 is connected to valve assembly 64 via drive piston 46. Connector 114 is connected to drive piston 46. In the example shown, connector head 122 is disposed at least partially within piston head 52 of drive piston 46. Connector head 122 is connected to drive piston 46 such that connector 114 and drive piston 46 move simultaneously along spray axis SA. Connector shaft 120 extends in second axial direction AD2 away from drive piston 46.

Converter 112 extends between and connects knob 42 and connector 114. Converter 112 is configured to convert rotational motion of knob 42 into axial movement of connector 114, and thus axial movement of drive piston 46 and valve assembly 64. In the example shown, converter body 116 is connected to knob 42 by shutoff fastener 142. Shutoff fastener 142 fixes converter body 116 and knob 42 together. Converter body 116 is connected to knob 42 for simultaneous rotation, such that rotating knob 42 causes rotation of converter body 116. In the example shown, converter 112 is disposed coaxial with spray axis SA and is converter body 116 is configured to rotate on spray axis SA.

Positioner 118 is supported by connector 114. In the example shown, the positioner 118 is supported by connector shaft 120. More specifically, the positioner 118 extends through connector shaft 120 in the example shown. Positioner 118 extends radially outward from connector shaft 120. Positioner 118 interfaces with converter body 116. Positioner 118 and converter body 116 together translate rotational movement of knob 42 into axial movement of connector 114 along spray axis SA. The positioner 118 extends into slots formed in the converter body 116, as discussed in more detail below.

Knob 42 is disposed outside of gun body 30 and is accessible from an exterior of sprayer 10. Knob 42 is accessible by a user to actuate shutoff 22 between the locked and unlocked states. Knob 42 is configured to be rotated on spray axis SA to actuate shutoff 22 between the locked and unlocked states. With shutoff 22 in the locked state, the sprayer 10 is locked in the non-spray state such that the valving components within cartridge 14 cannot be actuated to open the flowpaths for the constituent materials to flow to mix chamber 110. With shutoff in the unlocked state, the drive piston 46 is movable along the spray axis SA and the sprayer 10 can be placed in the spray state such that the valving components within cartridge 14 can be actuated to open the flowpaths for the constituent materials to flow to mix assembly 16. In the example shown, knob 42 provides a user interface of the shutoff 22.

During operation, trigger 24 is actuated and released to actuate sprayer 10 between the non-spray state and the spray state. Compressed gas is directed to opposite sides of piston head 52 of drive piston 46 to displace drive piston 46 axially and actuate the flow valves 58a, 58b between various operating states. Sprayer 10 is initially in the non-spray state shown in FIG. 2A. Compressed gas is provided to the sprayer 10 via gas fitting 26 and is routed to cartridge 14 through gun body 30. The constituent materials are provided to manifold 18 and routed to cartridge 14 from manifold 18.

With sprayer 10 in the non-spray state, each of the flow valves 58a, 58b are in the first open state. The constituent materials can flow to the flow chambers 70a, 70b but are blocked from flowing downstream to the mix chamber 110 by the valve members 88a, 88b. The compressed gas flows to gas chambers 72a, 72b and can flow through feed channels 134a, 134b and to mix chamber 110.

Actuation of trigger 24 causes gas valve 44 to direct compressed gas to the chamber on the side of piston head 52 oriented in second axial direction AD2. The compressed gas displaces drive piston 46 in first axial direction AD1 (the downstream direction). The drive piston 46 displaces valve assembly 64 in first axial direction AD1. The drive piston 46 exerts axial force on valve assembly 64 at dynamic interface 128 and displaces valve assembly 64 in first axial direction AD1. In the example shown, the drive piston 46 exerts axial force on coupler 90. Coupler 90 exerts axial driving force on valve members 88a, 88b to displace valve members 88a, 88b axially.

Valve members 88a, 88b are displaced to respective second positions (FIG. 2B). With valve member 88a in the second position, the component A liquid can flow from the flow chamber 70a (which receives component A liquid from the material inlet 38a of the manifold 18) to the feed channel 134a and into the mix chamber 110. Valve member 88a while in the second position shuts off a flow path for the compressed gas from gas chamber 72a to the feed channel 134a and into the mix chamber 110. The gas chamber 72a can be pressurized with compressed gas but be fluidly blocked from flowing into the feed channel 134a by valve member 88a while the valve member 88a is in the second position. The state in which the valve member 88a is in the second position corresponds to the state in which the trigger 24 is actuated for spraying, such actuation causing the drive piston 46 to be in a second, spray position (e.g., forward or downstream direction in this case).

With valve member 88b in the second position, the component B liquid can flow from the flow chamber 70b (which receives component B liquid from the material inlet 38b of the manifold 18) to the feed channel 134b and into the mix chamber 110. Valve member 88b while in the second position shuts off a flow path for the compressed gas from gas chamber 72b to the feed channel 134b and into the mix chamber 110. The compressed gas chamber 72b can be pressurized with compressed gas but be fluidly blocked from flowing into the feed channel 134b by valve member 88b while the valve member 88b is in the second position. The state in which the valve member 88b is in the second position corresponds to the state in which the trigger 24 is actuated for spraying, such actuation causing the drive piston 46 to be in a second, spray position (e.g., forward or downstream direction in this case).

The constituent materials flow from the flow chambers 70a, 70b and to the feed channels 134a, 134b. The constituent materials enter mix chamber 110 through chamber bores 140a, 140b, which are aligned with feed channels 134a, 134b, and interact within mix bore 138 to form the plural component material. The plural component material flows through mix bore 138 and is emitted from spray orifice 28. Compressed gas can flow to air cap 36 and be emitted from air cap 36 at locations around spray orifice 28 while flow valves 58a, 58b are in the respective second open states.

Trigger 24 is released to stop spraying by sprayer 10. Release of the trigger 24 causes gas valve 44 to shift to direct compressed gas to the chamber in housing 32 on the side of piston head 52 that is oriented in first axial direction AD1. The compressed gas provided to that chamber exerts an axial force on drive piston 46 to displace drive piston 46 in second axial direction AD2. Further, the gas valve 44 fluidly connects the other chamber in housing 32 to an exhaust 144 formed through handle 34 to vent compressed gas from sprayer 10.

Release of trigger 24 causes the compressed gas to displace the drive piston 46 to a first, non-spray position (e.g., rearward or upstream direction in this case). In this particular embodiment, the first position of the drive piston 46 is in the upstream direction while the second position of the drive piston 46 is in the downstream direction. Such movement of the piston 46 in second axial direction AD2 moves the valve members 88a, 88b to their respective first positions. The drive piston 46 displaces valve assembly 64 in second axial direction AD2. The drive piston 46 exerts axial force on valve assembly 64 at dynamic interface 128 and displaces valve assembly 64 in second axial direction AD2. In the example shown, the drive piston 46 exerts axial force on coupler 90 and coupler 90 exerts axial driving force on valve members 88a, 88b to displace valve members 88a, 88b axially rearward.

When the valve member 88a moves to the first position (such first position being further along the upstream direction than the second position), such as upon release of the trigger 24, the valve member 88a moves to unblock the gas chamber 72a from flowing to the feed channel 134a to route compressed gas into the mix chamber 110, but such positioning resumes blockage of the flow of component A liquid from the flow chamber 70a to the feed channel 134a. In the example shown, the valve member 88a transitions through the third position prior to returning to the first position from the second position. With the valve member 88a in the third position, associated with the closed state of flow valve 58a, the flow of compressed gas from gas chamber 72a to mix chamber 110 is blocked and the flow of component A liquid from flow chamber 70a to mix chamber 110 is blocked. Valve member 88a is in one of two positions when sprayer 10 is emitting from spray orifice 28, the second position allowing the component A liquid to flow into the mix chamber 110 for spraying while blocking compressed gas from flowing into the mix chamber 110, and in the first position blocking the component A liquid from flowing into the mix chamber 110 while permitting compressed gas to flow into the mix chamber 110 for purging. Actuation of the trigger 24 causes the valve member 88a to move into the second position and release of the trigger 24 causes valve member 88a to move into the first position.

When the valve member 88b moves to the first position (such first position being further along the upstream direction than the second position), such as upon release of the trigger 24, the valve member 88b moves to unblock the gas chamber 72b from flowing to the feed channel 134b to route compressed gas into the mix chamber 110, but such positioning resumes blockage of the flow of component B liquid from the flow chamber 70b to the feed channel 134b. In the example shown, the valve member 88b transitions through the third position, associated with the closed state of flow valve 58b, prior to returning to the first position from the second position. With the valve member 88b in the third position, the flow of compressed gas from gas chamber 72b to mix chamber 110 is blocked and the flow of component B liquid from flow chamber 70b to mix chamber 110 is blocked.

Valve member 88b is in one of two positions when sprayer 10 is emitting from spray orifice 28, the second position allowing the component B liquid to flow into the mix chamber 110 for spraying while blocking compressed gas from flowing into the mix chamber 110, and in the first position blocking the component B liquid from flow into the mix chamber 110 while permitting compressed gas to flow into the mix chamber 110 for purging. Actuation of the trigger 24 causes the valve member 88b to move into the second position and release of the trigger 24 causes valve member 88b to move into the first position.

Each valve member 88 is mounted to coupler 90 for simultaneous actuation. Mechanical motion from the drive piston 46 is transmitted from the actuator assembly 12 to the cartridge 14 by dynamic interface 128 for actuating the flow valves 58a, 58b between various states. The drive piston 46 is directly connected to the coupler 90, or indirectly connected to the coupler 90 by one or more intermediary parts, depending on the embodiment. The valve members 88a, 88b are connected directly or indirectly to the coupler 90. As such, actuation of the trigger 24 causes the drive piston 46 to move between the first and a second position which causes the valve members 88a, 88b correspondingly move to a first position or a second position, blocking and unblocking the component liquids A and B and compressed gas flows to the mix chamber 110. The dynamic interface 128 can be broken to dismount the cartridge 14 from the gun body 30, as further discussed herein.

While the mechanical motion to move valve members 88a, 88b comes from pneumatic operation initiated from the trigger 24, in a rare event air pressure may be lost while sprayer 10 is in the spray state and spraying, thus requiring quick manual shut off of the constituent material flows to cease spraying of the plural component material due to the trigger 24 not being able to move piston 46 pneumatically via gas valve 44. Such motion is provided by the shutoff 22. Knob 42 is accessible by the user to actuate shutoff 22. The knob 42 can be on the rear or upstream side of the gun body 30, opposite the spray orifice 28. The knob 42 can be rotated about the spray axis SA, amongst other options. Actuation of the knob 42 provides mechanical input to converter 112. In this embodiment, the converter 112 converts rotational motion to linear motion. More specifically, the knob 42 can be turned, providing rotational input to the converter body 116. The converter body 116 displaces positioner 118 along slots formed in the converter body 116, which exerts an axial driving force on positioner 118. Positioner 118 is connected to connector 114 to exert an axial driving force on connector 114. The connector 114 is attached to drive piston 46 and can mechanically displace drive piston 46.

The shutoff 22 attaches to drive piston 46 and can displace drive piston 46 in second axial direction AD2 to pull the valve members 88a, 88b rearward to actuate flow valve 58a to shut off the component A flow to mix chamber 110 and actuate flow valve 58b to shut off the component B flow to mix chamber 110. The positioner 118 can comprise a pin, knob, or other projection that interfaces with a helical structure of the converter body 116. The helical structure can wrap partially or fully around the spray axis SA, amongst other options. The positioner 118 may be fixed to only be able to translate linearly along the spray axis SA, such that interfacing with the rotating helical structure causes the pin, knob, or other projection to move linearly along the spray axis SA. The positioner 118 may be connected directly or indirectly with the drive piston 46 (via connector 114 in the example shown) which drive piston 46 is indirectly connected to the valve members 88a, 88b via coupler 90.

Cartridge 14 is disposed coaxially with shutoff 22 and drive piston 46 on spray axis SA. Cartridge 14 is configured to shift in second axial direction AD2 relative to gun body 30 during mounting to actuator assembly 12 and cartridge 14 is configured to shift in first axial direction AD1 relative to gun body 30 during dismounting from actuator assembly 12. Mix chamber cavity 68 is disposed coaxially with the piston bore 146 that the piston shaft 50 of drive piston 46 extends through to interface with valve assembly 64 at dynamic interface 128.

In the example shown, cartridge 14 interfaces with actuator assembly 12 at three distinct locations. The first interface is formed between valving body 60 and gun body 30 at static interface 126. The static interface 126 connects cartridge 14 to gun body 30 to secure cartridge 14 on gun body 30. The second interface is formed between valve assembly 64 and drive piston 46 at dynamic interface 128. The dynamic interface 128 transmits mechanical force from actuator assembly 12 to cartridge 14 to actuate flow valves 58a, 58b between various operating states, thereby controlling flow of constituent material and compressed gas to mix chamber 110. The third interface is formed between cartridge 14 and drive piston 46. More specifically, the third interface is formed between gas stem 82 and drive piston 46. The third interface does not transmit mechanical driving force between actuator assembly 12 and cartridge 14. In the example shown, the third interface is formed as a telescoping interface in which a component of the actuator assembly 12 moves relative to a component of the cartridge 14 (drive piston 46 moving relative to gas stem 82 in the example shown). Compressed gas is transmitted from actuator assembly 12 to cartridge 14 at the third interface.

Sprayer 10 provides significant advantages. Cartridge 14 is mounted to actuator assembly 12 at static interface 126 and dynamic interface 128. The static interface 126 connects cartridge 14 to gun body 30 and mechanically supports cartridge 14 on gun body 30. The dynamic interface 128 conveys mechanical motion from drive piston 46 to valve assembly 64 to actuate flow valves 58a, 58b between various operating states. The static interface 126 and the dynamic interface 128 are both formed during mounting of the cartridge 14 and both broken during dismounting of the cartridge 14. The static interface 126 and dynamic interface 128 provide for easy and quick mounting and dismounting of cartridge 14.

Cartridge 14 contains flow valves 58a, 58b such that flow valves 58a, 58b mount with and dismount with cartridge 14. As such, the flow valves 58a, 58b that control flow of constituent materials to mix chamber 110 mount with and dismount with cartridge 14. Having cartridge 14 fully contain the flow valves 58a, 58b allows for quick and simple dismounting of the valving components and replacement of the valving components, such as by mounting a new cartridge 14.

Shutoff 22 can lock sprayer 10 in the non-spray state to prevent actuation of sprayer 10 to the spray state. Shutoff 22 can further actuate flow valves 58a, 58b to shut off flow of constituent materials to the mix chamber 110. Shutoff 22 provides a single mechanism that can both lock sprayer 10 in the spray state and provide the actuation in case of loss of motive power to drive piston 46. Shutoff 22 provides a simple configuration that is easily accessible by the user and provides multiple functions by the single assembly.

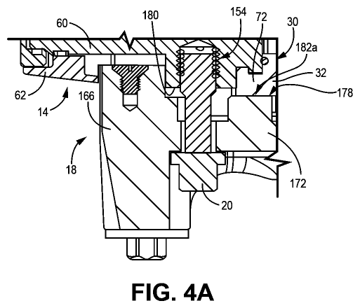

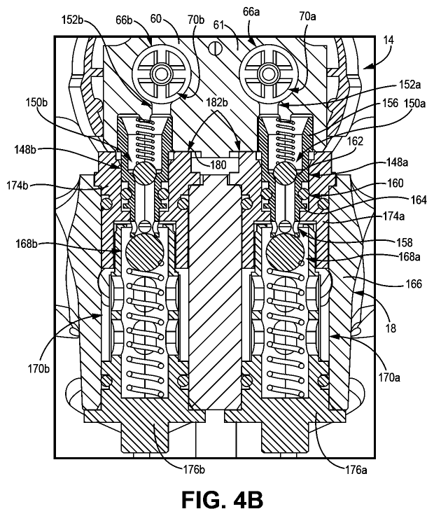

FIG. 4A is an enlarged view of detail 4A in FIG. 3. FIG. FIG. 4B is a cross-sectional view taken along line 4B-4B in FIG. 3 showing an interface between cartridge 14 and manifold 18. FIGS. 4A and 4B are discussed together and with continued reference to FIGS. 1A-3. Cartridge 14, manifold 18, fastener 20, and gun body 30 of sprayer 10 are shown. Valving body 60, valve bores 66a, 66b; cartridge inlets 148a, 148b; inlet checks 150a, 150b; bore inlets 152a, 152b; and fastener opening 154 of cartridge 14 are shown. Each cartridge inlet 148a, 148b includes inlet body 156, inlet orifices 158, inlet seal 160, shoulder 162, and flange 164. Manifold body 166; manifold valves 168a, 168b; manifold passages 170a, 170b; manifold brace 172; valve caps 174a, 174b; and valve housings 176a, 176b of manifold 18 are shown. Body slot 178 of gun body 30 is shown.

Manifold 18 is connectable to constituent material lines to receive constituent materials from pumps. Manifold 18 is configured to route the constituent materials to cartridge 14. Manifold body 166 supports other components of manifold 18. Manifold passages 170a, 170b define flowpaths for the constituent materials to flow to the cartridge 14. Manifold passages 170a, 170b are fluidly separated from each other within manifold body 166. The constituent materials are isolated from each other within manifold body 166 and do not mix within manifold body 166.

Manifold brace 172 is formed by manifold body 166. Manifold brace 172 projects from other portions of manifold body 166. Manifold brace 172 is configured to interface with a portion of gun body 30 with manifold 18 mounted to cartridge 14. In the example shown, manifold brace 172 extends into body slot 178 formed in housing 32 of gun body 30. The body slot 178 is formed on a lower side of housing 32. The manifold brace 172 projects into body slot 178 and can interface with portions of gun body 30 forming body slot 178. The manifold brace 172 interfacing with gun body 30 within body slot 178 inhibits rotation of cartridge 14 relative to gun body 30 and about spray axis SA during operation of sprayer 10. Removal of manifold 18 from cartridge 14 allows cartridge 14 to be rotated relative to gun body 30 for mounting and dismounting of cartridge 14 from gun body 30. It is understood that, while manifold 18 can directly interface with gun body 30 to lock an orientation of cartridge 14 during operation, manifold 18 is not directly connected to gun body 30; instead, manifold 18 is mounted directly to cartridge 14 such that cartridge 14 fully supports manifold 18.

Manifold valves 168a, 168b are disposed within manifold passages 170a, 170b, respectively. Manifold valves 168a, 168b are configured as normally-closed valves that are actuated to open states by cartridge 14. Manifold valves 168a, 168b are not check valves that are opened and closed by flow relative to the valve. Instead, manifold valves 168a, 168b are configured to remain in respective closed states until actuated open by the cartridge 14 interfacing with and driving the manifold valves 168a, 168b to respective open states. The cartridge 14 can maintain the manifold valves 168a, 168b in respective open states throughout the time that manifold 18 is mounted to cartridge 14. In the example shown, manifold valves 168a, 168b are spring-biased ball valves, though it is understood that other configurations are possible.

Valve housings 176a, 176b are mounted to manifold body 166. Valve housing 176a is at least partially disposed in manifold passage 170a. Valve housing 176b is at least partially disposed in manifold passage 170b. Valve housings 176a, 176b include arrays of openings through which constituent materials can enter into the valve housing 176a, 176b from the associated manifold passage 170a, 170b. Valve caps 174a, 174b are mounted to manifold body 166. Valve caps 174a, 174b can form the seats for the movable valving components (e.g., balls in the example shown) of the manifold valves 168a, 168b.

Cartridge inlets 148a, 148b project from valving body 60. In the example shown, cartridge inlets 148a, 148b extend from block body 61 of valving body 60. Cartridge inlet 14a extends from the valving body 60 at a first location between the first body end 94 and the second body end 96. Cartridge inlet 14b extends from the valving body 60 at a second location between the first body end 94 and the second body end 96. Cartridge inlets 148a, 148b can also be referred to as material inlets that receive constituent material into cartridge 14. In the example shown, cartridge inlets 148a, 148b project vertically downward away from valving body 60. Cartridge inlets 148a, 148b extend away from the spray axis SA as the cartridge inlets 148a, 148b project from valving body 60. Cartridge inlets 148a, 148b are radially offset from spray axis SA. Cartridge inlets 148a, 148b are in fluid communication with valve bores 66a, 66b, respectively, via bore inlets 152a, 152b formed in valving body 60. The bore inlets 152a, 152b extend radially relative to the valve axis VA of the valve bore 66a, 66b that is fluidly connected with that bore inlet 152a, 152b. The bore inlets 152a, 152b define flowpaths for constituent materials to flow to flow chambers 70a, 70b of valve bores 66a, 66b from cartridge inlets 148a, 148b.

In the example shown, cartridge 14 is configured such that the first and second constituent materials do not enter into the cartridge 14 through either axial end of the cartridge 14. The first and second constituent materials do not enter into the valving body 60 through either the first body end 94 or the second body end 96.

In the examples shown, the bore inlet 152a, flow chamber 70a, and feed channel 134a form a material flowpath for the first constituent material to flow within valving body 60 and to mix chamber cavity 68 with flow valve 58a in the second open state. In the examples shown, the bore inlet 152b, flow chamber 70b, and feed channel 134b form a material flowpath for the second constituent material to flow within valving body 60 and to mix chamber cavity 68 with flow valve 58b in the second open state.

For each cartridge inlet 148a, 148b, the inlet body 156 is connected to valving body 60. Inlet body 156 defines a flowpath for constituent materials to flow to a respective valve bore 66a, 66b. The inlet body 156 can be connected to valving body 60 in any desired manner, such as by interfaced threading, among other options. In some examples, inlet body 156 can be formed monolithically with valving body 60. Inlet body 156 projects from the lower side 180 of valving body 60. Inlet body 156 projects away from valving body 60. In the example shown, each inlet body 156 forms a discrete projection that extends away from valving body 60.

Inlet orifices 158 are formed through inlet body 156. Inlet orifices 158 form openings through which constituent material flows to enter into cartridge 14 from manifold 18. In the example shown, each cartridge inlet 148a, 148b includes an array of inlet orifices 158 disposed about the inlet body 156. Each inlet body 156 includes multiple inlet orifices 158 in the example shown.

Shoulder 162 is formed by inlet body 156. Shoulder 162 projects inward within inlet body 156 and forms a seat for the inlet check 150a, 150b of that cartridge inlet 148a, 148b. Inlet seal 160 is disposed on an exterior of cartridge inlet 148a, 148b. The inlet seal 160 is configured to interface with manifold 18 to prevent leakage of constituent material between inlet body 156 and manifold 18. In the example shown, inlet seal 160 is supported by inlet body 156 and interfaces with an interior surface of a valve cap 174a, 174b. Flange 164 projects outward from inlet body 156 and is configured to retain inlet seal 160 on inlet body 156.

Inlet checks 150a, 150b are disposed within cartridge 14. Inlet checks 150a, 150b are configured to prevent retrograde flow out of cartridge 14 and to manifold 18. Inlet checks 150a, 150b thereby protect manifold 18 from retrograde flow, such as if cross-over of the constituent materials occur within valving body 60 resulting in plural component material in flowpaths within cartridge 14. The inlet checks 150a, 150b prevent that plural component material from flowing to manifold 18, which could cure within manifold 18 rendering manifold 18 inoperable.

Fastener 20 mounts manifold 18 to cartridge 14. Fastener 20 extends through manifold body 166 and into fastener opening 154 formed in valving body 60. In the example shown, the fastener 20 is formed as a threaded fastener that includes exterior threading that mates with interior threading formed within valving body 60. Fastener 20 extends fully through manifold body 166 to interface with valving body 60.

With manifold 18 mounted to cartridge 14, manifold 18 can interface with gun body 30 and with lower side 180 of valving body 60. The fastener 20 extends into valving body 60 at a location disposed axially between the first interface 182a between manifold brace 172 and gun body 30 and the second interface 182b between valve caps 174a, 174b and lower side 180. The fastener exerts a clamping force to secure manifold 18 to cartridge 14. That clamping force is balanced between the two interfaces 182a, 182b, providing a robust connection while maintaining alignment between cartridge inlets 148a, 148b and the flowpaths through manifold 18.

During assembly of sprayer 10, the cartridge 14 is mounted to actuator assembly 12 to form the static interface 126 and the dynamic interface 128, as discussed in more detail below. The manifold 18 is mounted to cartridge 14 with cartridge 14 mounted on actuator assembly 12. One of the manifold 18 and cartridge 14 is shifted relative to the other one of manifold 18 and cartridge 14 such that cartridge inlets 148a, 148b enter into manifold 18. The cartridge inlets 148a, 148b enter into manifold 18 through valve caps 174a, 174b, respectively. The distal ends of the inlet bodies 156 contact the manifold valves 168a, 168b and displace the manifold valves 168a, 168b to open states. In the example shown, the distal ends of the inlet bodies 156 contact the balls of the manifold valves 168a, 168b and bias the balls away from the seats of the manifold valves 168a, 168b. The inlet bodies 156 hold the manifold valves 168a, 168b in respective open states. The manifold valves 168a, 168b remain open with manifold 18 mounted to cartridge 14. Fastener 20 is inserted through manifold 18 and connected to valving body 60. The fastener 20 secures manifold 18 to cartridge 14.

During disassembly of sprayer 10, the fastener 20 is disconnected from valving body 60. The manifold 18 can then be pulled off of cartridge 14. Cartridge inlets 148a, 148b are withdrawn from manifold 18 and the manifold valves 168a, 168b return to their respective closed states. The manifold valves 168a, 168b prevent leakage from manifold 18 when manifold 18 is not mounted to sprayer 10. The manifold valves 168a, 168b automatically returning to the closed states when manifold 18 is dismounted from cartridge 14 prevents material that is within manifold passages 170a, 170b, but downstream of material valves 40a, 40b, from leaking from manifold 18, providing for easier and cleaner assembly and disassembly of sprayer 10. With manifold 18 dismounted from cartridge 14, the static interface 126 and dynamic interface 128 can be broken and cartridge 14 can be dismounted from actuator assembly 12.

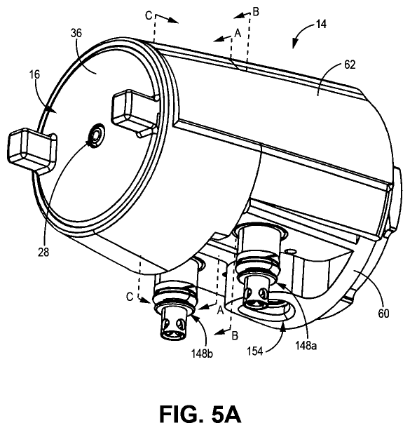

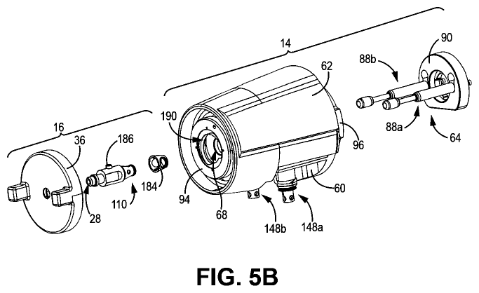

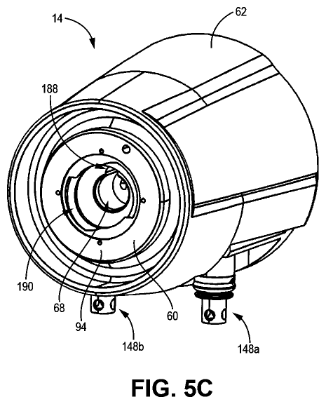

FIG. 5A is an isometric view of cartridge 14 with mix assembly 16 mounted to cartridge 14. FIG. 5B is an exploded view of cartridge 14 and mix assembly 16. FIG. 5C is an isometric view of cartridge 14 with mix assembly 16 dismounted to expose mix chamber cavity 68. FIGS. 5A-5C are discussed together with continued reference to FIGS. 1A-4B. Valving body 60, outer body 62, valve assembly 64, mix chamber cavity 68, cartridge inlets 148a, 148b, and fastener opening 154 of cartridge 14 are shown. Valve members 88a, 88b and coupler 90 of valve assembly 64 are shown. Air cap 36, mix chamber 110, chamber seal 184, and locator 186 of mix assembly 16 are shown.

Cartridge 14 is configured to mount to and dismount from gun body 30 of sprayer 10 as a single module. Valving body 60 is at least partially disposed within outer body 62. Cartridge inlets 148a, 148b project from valving body 60 and are configured to extend into manifold 18 to receive individual flows of the constituent materials from manifold 18.

Valve assembly 64 is at least partially disposed within valving body 60. Valve assembly 64 is removable from valving body 60 for maintenance or replacement of valve assembly 64. For example, valve assembly 64 can be pulled in second axial direction AD2 to remove valve members 88a, 88b from valve bores 66a, 66b. The same or a new valve assembly 64 can be mounted to valving body 60 by shifting the valve assembly 64 in first axial direction AD1 relative to valve body 60 to insert valve members 88a, 88b into valve bores 66a, 66b. Valve assembly 64 is movable relative to valving body 60 during operation of sprayer 10. Valve members 88a, 88b are mounted to coupler 90. Coupler 90 is configured to connect with drive piston 46 at dynamic interface 128. Coupler 90 transmits axial driving forces from drive piston 46 to valve members 88a, 88b to displace valve members 88a, 88b axially during operation.

Mix assembly 16 is mountable to and dismountable from cartridge 14. Mix assembly 16 can remain mounted on cartridge 14 during mounting of cartridge 14 on gun body 30 and during dismounting of cartridge 14 from gun body 30. Mix chamber 110 is configured to be disposed at least partially within mix chamber cavity 68 during operation of sprayer 10. Mix chamber seal 184 is mounted on mix chamber 110 and is configured to interface with valving body 60 at a location within mix chamber cavity 68. The mix chamber seal 184 engages with mix chamber 110 and valving body 60 to prevent leakage (e.g., of compressed gas or constituent material) between mix chamber 110 and valving body 60.

Locator 186 extends from mix chamber 110. Locating groove 188 is formed in valving body 60 and extends axially and radially. Locator 186 is configured to be disposed in locating groove 188 to ensure alignment between chamber bores 140a, 140b of mix chamber 110 and feed channels 134a, 134b with mix chamber 110 mounted to cartridge 14. Locator 186 being disposed in locating groove 188 limits mix chamber 110 to axial displacement during mounting and dismounting of mix chamber 110 from cartridge 14.

Air cap 36 is mountable to mix chamber 110. Air cap 36 is configured to guide compressed air and output compressed air around spray orifice 28 of mix chamber 110. Such compressed air can be referred to as clean-off air that prevents blows material off of mix chamber 110. Air cap 36 can be rotated relative to mix chamber 110 to mount air cap 36 to cartridge 14. In the example shown, cap chamber 190 is formed in first body end 94 of valving body 60. The cap chamber 190 extends in first axial direction AD1 relative to mix chamber cavity 68. The cap chamber 190 includes female threading that is configured to interface with male threading on air cap 36 to mount air cap 36 to cartridge 14.

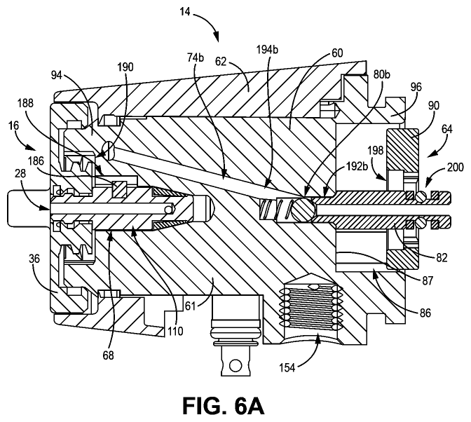

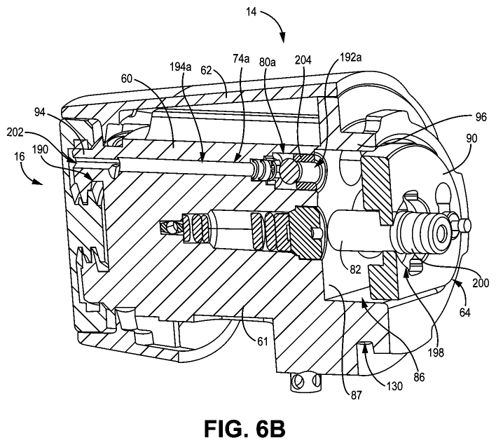

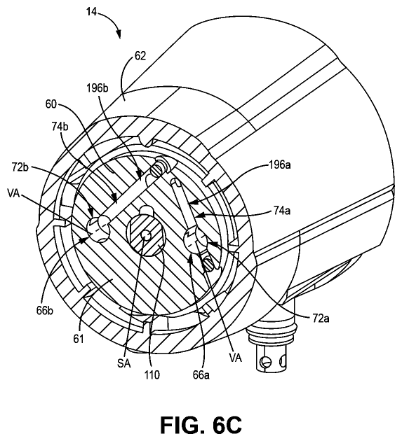

FIG. 6A is a cross-sectional view taken along line A-A in FIG. 5A. FIG. 6B is a cross-sectional view taken along line B-B in FIG. 5A. FIG. 6C is a cross-sectional view taken along line C-C in FIG. 5A. FIGS. 6A-6C will be discussed together and with continued reference to FIGS. 1A-5C. FIGS. 6A-6C show the gas passages through cartridge 14. Cartridge 14 and mix assembly 16 are shown. Valving body 60, outer body 62, valve assembly 64, valve bores 66a, 66b, mix chamber cavity 68, gas chambers 72a, 72b, gas channels 74a, 74b; gas checks 80a, 80b; and gas stem 82 of cartridge 14 are shown. Air cap 36 and mix chamber 110 of mix assembly 16 are shown.

Cartridge 14 is shown dismounted from actuator assembly 12 with mix assembly 16 mounted to cartridge 14. Cartridge 14 is configured to provides flows of constituent material to mix assembly 16 for mixing within mix chamber 110 to form the plural component material that is emitted as a spray. Cartridge 14 is further configured to provide flows of compressed gas to mix assembly 16 for flowing through mix chamber 110 to purge residual material from mix chamber 110 and for flowing to air cap 36 for emission around spray orifice 28. In the example shown, cartridge 14 is configured to route discrete flows of the compressed gas to the mix assembly 16. It is understood, however, that not all examples are so limited. For example, cartridge 14 can include a single gas passage that branches within valving body 60 to provide compressed gas to both gas chambers 72a, 72b.

Maintaining the gas flows as separate flows within cartridge 14 can provide significant advantages. For example, some examples of sprayer 10 can be configured to intermittently provide solvent to mix chamber 110 throughout operation. The solvent assists in clearing mix chamber 110 of residue with sprayer 10 in the non-spray mode, which non-spray state can also be referred to as a purge state as purge air is flowed to and through mix chamber 110. The solvent can slow the reaction process of the plural component material to inhibit curing within mix chamber 110 and can dissolve uncured plural component material.

In the example shown, gas channel 74b is configured to direct compressed gas that includes dosed solvent to mix chamber 110. Providing the solvent through only gas channel 74b prevents mixing of the solvent with the component A material provided through valve bore 66a at locations upstream of mix chamber 110. For example, valve bore 66b can be configured to provide the resin constituent material to mix chamber 110 while valve bore 66a can be configured to provide the isocyanate constituent material. Isocyanate is moisture-sensitive and can cure when exposed to a liquid, such as the solvent. The cured isocyanate can form crystals that can cause scoring or other damage to soft seals and clogging of pathways through cartridge 14. Flowing the solvent into mix chamber 110 through the same port as the resin (e.g., through feed channel 134b) prevents mixing of solvent and isocyanate within cartridge 14 at locations upstream of mix chamber 110. In the examples shown, the dose piston 48 is configured to dose the solvent into the compressed gas flow that is provided to gas channel 74b.

Gas channel 74b extends through valving body 60 between gas inlet 192b and gas chamber 72b. At least a portion of gas channel 74b is disposed coaxially with mix chamber cavity 68 on spray axis SA. Gas inlet 192b is formed through chamber wall 87 and is open to body chamber 86 when gas stem 82 is not mounted to valving body 60. In the example shown, the gas channel 74b includes first gas path 194b that extends axially in first axial direction AD1 and radially outward relative to spray axis SA within valving body 60. Second gas path 196b intersects with first gas path 194b at a location radially offset from spray axis SA and from the valve axis VA of valve bore 66b. Second gas path 196b extends radially towards the valve axis VA of valve bore 66b and intersects with gas chamber 72b at a location spaced in first axial direction AD1 from feed channel 134b. Gas channel 74b is not open through first body end 94 of valving body 60. Gas channel 74b does not extend fully through valving body 60 in the example shown.

In the example shown, gas stem 82 is connected to valving body 60 at gas inlet 192b. Gas stem 82 extends axially in second axial direction AD2. Gas stem 82 extends through aperture 198 in coupler 90. Gas stem 82 is configured to extend into drive piston 46 to interface with drive piston 46 during operation of sprayer 10. Gas stem 82 is mounted to valving body 60 in the example shown such that gas stem 82 remains stationary during operation while drive piston 46 moves along spray axis SA to displace valve assembly 64. Gas stem 82 projects fully through the aperture 198 with sprayer 10 in the spray state and with sprayer 10 in the non-spray state. Gas stem 82 extends fully through body chamber 86 and projects beyond the second body end 96 of valving body 60. A portion of gas channel 74b upstream of gas check 80b is formed in gas stem 82.

Stem seal 200 is mounted on gas stem 82. Stem seal 200 is configured to engage with an interior surface of the drive piston 46 to inhibit leakage of compressed gas about the exterior of gas stem 82. While gas stem 82 is shown as mounted to valving body 60, it is understood that not all examples are so limited. For example, the gas stem 82 can be mounted to the drive piston 46 to move with drive piston 46 and can extend into and seal with valving body 60. In such an example, the stem seal 200 can be mounted to interface with the valving body 60 and to slide relative to the valving body 60 as the gas stem 82 moves with the drive piston 46. In both examples, the gas stem 82 bridges the axial gap between valving body 60 and drive piston 46 along spray axis SA. The gas stem 82 provides a conduit that transmits compressed gas from drive piston 46 to valving body 60 while maintaining that flow of compressed gas separate from the flow of compressed gas transmitted through gas channel 74a.

Gas check 80b is configured to prevent retrograde flow through gas channel 74b. In the example shown, gas check 80b is disposed in valving body 60. Gas check 80b is disposed coaxially on spray axis SA in the example shown. Gas check 80b is a spring-loaded ball valve in the example shown, though it is understood that gas check 80b can be of any desired configuration suitable for allowing one-way flow through gas channel 74b. Gas stem 82 forms the seat for the ball of gas check 80b in the example shown. While gas check 80b is shown as disposed within valving body 60, it is understood that not all examples are so limited. For example, gas check 80 can be disposed within drive piston 46, such as in examples in which gas stem 82 is mounted to drive piston 46 to move with drive piston 46.

Gas channel 74a extends through valving body 60. Gas channel 74a is configured to output compressed gas to gas chamber 72a and to air cap 36. Gas channel 74a is configured to receive compressed through gas inlet 192a. Gas inlet 192a is formed through chamber wall 87. Gas inlet 192a is open to body chamber 86 and is configured to receive compressed gas from body chamber 86. In some examples, body chamber 86 is pressurized with compressed gas throughout operation of sprayer 10. The body chamber 86 is in fluid communication with a passage through gun body 30 that outputs the compressed gas from gun body 30 to cartridge 14.

Gas channel 74a is radially offset from spray axis SA. Gas channel 74a is configured to provide compressed gas to gas chamber 72a and to air cap 36 for emission about spray orifice 28. Gas channel 74 is open in both axial directions AD1 and AD2 through valving body 60.

In the example shown, the gas channel 74a includes first gas path 194a that extends axially in first axial direction AD1 within valving body 60. The first gas path 194a extends to gas outlet 202 formed through first body end 94 of valving body 60. Compressed gas is output from the gas outlet 202 to the air cap 36. The compressed gas is output to air cap 36 at a location radially outward of the cap chamber 190. The air cap 36 outputs that compressed gas about spray orifice 28. Gas channel 74a can continuously output compressed gas from the gas outlet 202 to air cap 36 regardless of the operating state of sprayer 10. As such, air cap 36 can output compressed gas about spray orifice 28 throughout operation, with sprayer 10 in either the spray state or the non-spray state and as sprayer 10 transitions between states.

Second gas path 196a intersects with first gas path 194a at a location radially offset from spray axis SA and from the valve axis VA of valve bore 66a. Second gas path 196a extends radially towards the valve axis VA of valve bore 66a and intersects with gas chamber 72a at a location spaced in first axial direction AD1 from feed channel 134a. The second gas path 196a intersects with the first gas path 194a at a location spaced in second axial direction AD2 from gas outlet 202. The compressed gas from gas chamber 72a can flow to mix chamber 110 through feed channel 134a with sprayer 10 in the non-spray state. Gas check 80a is configured to prevent retrograde flow through gas channel 74a. In the example shown, gas check 80a is disposed in valving body 60. Gas check 80a is disposed radially offset from spray axis SA and from each valve axis VA. Gas check 80a is a spring-loaded ball valve in the example shown, though it is understood that gas check 80a can be of any desired configuration suitable for allowing one-way flow through gas channel 74a. Valve seat 204 is mounted to valving body 60 and forms the seat of gas check 80a. For example, valve seat 204 can be mounted to valving body 60 by interfaced threading, among other options. Gas check 80a is mounted within valving body 60 proximate gas inlet 192a.

While cartridge 14 is described as including two distinct gas channels 74a, 74b within valving body 60 that route compressed gas and do not cross-over with each other, it is understood that not all examples are so limited. For example, some configurations of cartridge 14 can include a single gas channel within valving body 60 that branches within valving body 60 to both the valve bores 66a, 66b.

As shown, the coupler 90 is disposed at least partially in body chamber 86 but is spaced from the walls of projection 130 defining body chamber 86. The gaps between coupler 90 and body chamber 86 allow compressed gas to flow into body chamber 86 to pressurize body chamber 86. Body chamber 86 is not pressurized to displace coupler 90 but is instead pressurized to provide compressed gas to gas passages within valving body 60. The compressed gas can flow through the gap between coupler 90 and body chamber 86. Body chamber 86 does not form a drive chamber that is pressurized to cause displacement of valve assembly 64. Instead, valve assembly 64 receives mechanical input via dynamic interface 128 to actuate the flow valves 58a, 58b between various states.

Cartridge 14 provides significant advantages. The compressed gas flows provided to gas chamber 72a and gas chamber 72b are fluidly divided within cartridge 14 and do not combine until within mix chamber 110. The fluidly separated gas channels 74a, 74b facilitate flowing solvent to mix chamber 110 through a pathway that does not contain constituent material reactive to moisture. Maintaining the fluidly separated gas channels 74a, 74b prevents curing of such moisture-sensitive material at locations upstream of mix chamber 110, protecting sealing interfaces. Gas channel 74a, which is the gas passage that does not receive and transmit solvent, provides compressed gas to air cap 36 for cleaning off of mix chamber 110. The gas channel 74a provides dry air that does not contain solvent, preventing overuse of solvent and reducing material costs.

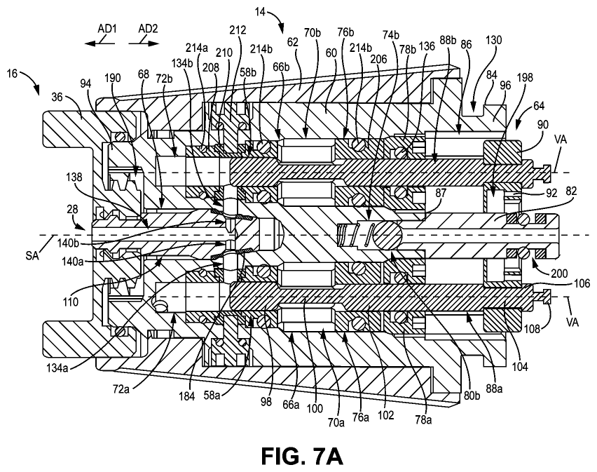

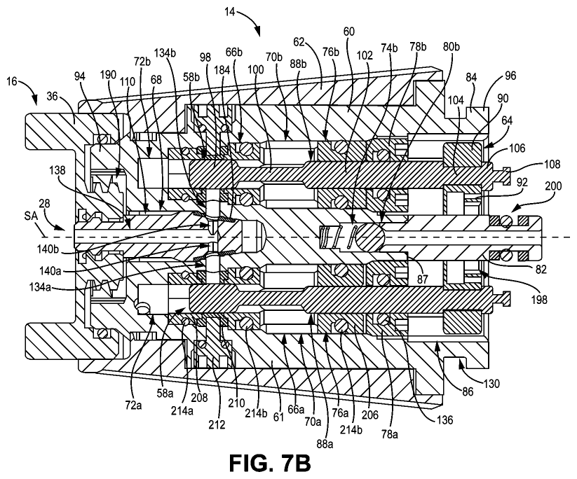

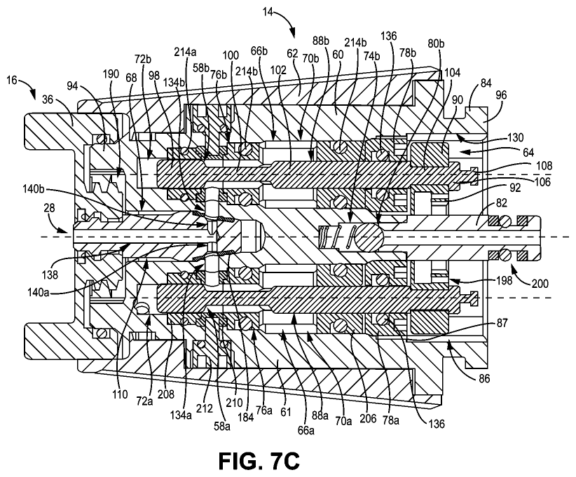

FIG. 7A is a cross-sectional view taken along line 7-7 in FIG. 5A showing valve assembly 64 in a position associated with the flow valves 58a, 58b being in respective first open states. FIG. 7B is a cross-sectional view taken along line 7-7 in FIG. 5A showing valve assembly 64 in a position associated with flow valves 58a, 58b being in respective closed states. FIG. 7C is a cross-sectional view taken along line 7-7 in FIG. 5A showing valve assembly 64 in a position associated with flow valves 58a, 58b being in respective second open states. FIGS. 7A-7C are discussed together and with continued reference to FIGS. 1A-6C.

Flow valves 58a, 58b; valving body 60; outer body 62; valve assembly 64; valve bores 66a, 66b; mix chamber cavity 68; flow chambers 70a, 70b; gas chambers 72a, 72b; gas channel 74b; seal bodies 76a, 76b; retainers 78a, 78b; gas check 80b; gas stem 82; body mount 84; and projection 130 of cartridge 14 are shown. Valve assembly 64 includes valve members 88a, 88b; coupler 90; and valve mount 92. Each valve member 88a, 88b includes a flow head 98, flow neck 100, member body 102, mount neck 104, mount head 106, and tail 108. Each seal body 76a, 76b includes material control body 206, gas control body 208, and body spacer 210. Mix assembly 16 includes air cap 36 and mix chamber 110.

Cartridge 14 is configured to mount to and be removed from the gun body 30 as a unitary component for quick replacement of valving that controls flows of constituent material and, in some example, compressed gas to mix chamber 110. Projection 130 is formed at second body end 96 of valving body 60. Body mount 84 is formed on projection 130 and is configured to interface with a portion of gun body 30 to form the static interface between cartridge 14 and gun body 30.

Valving body 60 defines flowpaths for constituent materials and compressed gas. Valving body 60 extends between first body end 94 and second body end 96. Cartridge 14 is configured such that first body end 94 is a spray output end of valving body 60 from which spray (e.g., plural component material, compressed gas) is emitted from cartridge 14. Cartridge 14 is configured such that connections with actuator assembly 12 (e.g., the driving connection at dynamic interface 128 and the support connection at static interface 126) are formed at second body end 96. In the example shown, valving body 60 does not receive constituent materials through second body end 96. In the example shown, valving body 60 does receive compressed gas at second body end 96. Valving body 60 is configured such that plural component material and compressed gas are output through first body end 94.

Mix chamber cavity 68 is formed in valving body 60. Mix chamber cavity 68 extends into valving body 60 from first body end 94 and is open in first axial direction AD1 through first body end 94. Mix chamber cavity 68 does not extend fully axially through valving body 60 and is not open through second body end 96. Mix chamber cavity 68 is not open through chamber wall 87. Mix chamber cavity 68 does not extend to chamber wall 87. The mix chamber 110 does not extend through dual axially aligned openings. Instead, the mix chamber 110 can be moved through only the opening of mix chamber cavity 68 oriented in first axial direction AD1, which movement occurs during mounting and dismounting of mix chamber 110, not during spray operations.

Cap chamber 190 extends in first axial direction AD1 from mix chamber cavity 68. Cap chamber 190 is disposed coaxially with mix chamber cavity 68 on spray axis SA. Cap chamber 190 has a larger diameter than mix chamber cavity 68. Cap chamber 190 is open through first body end 94 of valving body 60. In the example shown, the cap chamber 190 includes threading configured to interface with threading on air cap 36 to mount air cap 36 to valving body 60.

Mix assembly 16 is mountable to cartridge 14 to be supported by cartridge 14. In the example shown, mix assembly 16 is mounted to valving body 60. Mix assembly 16 is mounted to first body end 94 of valving body 60 in the example shown. Air cap 36 extends at least partially into valving body 60 to radially overlap with portions of valving body 60 with mix assembly 16 mounted to cartridge 14. In the example shown, air cap 36 is mounted to cartridge 14 by interfaced threading formed on air cap 36 and valving body 60. The threading on valving body 60 is formed in cap chamber 190. Cap chamber 190 extends in first axial direction AD1 relative to mix chamber cavity 68. Cap chamber 190 has a larger diameter than mix chamber cavity 68. The threading on valving body 60 that interfaces with air cap 36 is formed as female threading in the example shown. While air cap 36 is described as mounting to cartridge 14 by interfaced threading, it is understood that other connection types are possible, such as a bayonet connection among other options.

Spray orifice 28 is formed at a downstream end of mix chamber 110. Spray orifice 28 is formed by mix chamber 110 in the example shown. Mix chamber 110 is configured as a stationary mix chamber 110 in the example shown in that mix chamber 110 does not shift along spray axis SA to actuate sprayer 10 between spray and non-spray states. The mix chamber 110 is configured to remain stationary as flow valves 58a, 58b are actuated between various states to turn on and turn off flow of the constituent materials to the mix chamber 110.

Valve bores 66a, 66b extend into valving body 60. Valve bores 66a, 66b extend only partially axially through valving body 60 in the example shown. The valve bores 66a, 66b are open in second axial direction AD2 and are closed in first axial direction AD1. The valve bores 66a, 66b are open in second axial direction AD2 to allow valve members 88a, 88b to pass into valve bores 66a, 66b. The valve bores 66a, 66b are closed in first axial direction AD1 such that the valve members 88a, 88b cannot pass fully axially through valve bores 66a, 66b. Valve assembly 64 can be removed from valving body 60 by pulling valve assembly 64 in second axial direction AD2. A new or the same valve assembly 64 can be mounted to cartridge 14 by aligning valve members 88a, 88b with valve bores 66a, 66b, respectively, and shifting valve assembly 64 in first axial direction AD1 to cause valve members 88a, 88b to enter into valve bores 66a, 66b.

Each valve bore 66a, 66b extends along a valve axis VA. In the example shown, the valve axis VA is parallel with and radially offset from the spray axis SA. In some examples, a plane can be disposed through cartridge 14 along which each of the spray axis SA and the two valve axes VA extend. Valve bores 66a, 66b defines flowpaths for constituent material and compressed gas to flow to mix chamber 110.

Valve bores 66a, 66b are open though chamber wall 87 of valving body 60. Chamber wall 87 forms a downstream end of body chamber 86. Projection 130 extends in second axial direction AD2 from chamber wall 87. The projection 130 extends in second axial direction AD2 from block body 61 of valving body 60. The body chamber 86, which is open in second axial direction AD2 through second body end 96, is at least partially defined by chamber wall 87 and by projection 130. The chamber wall 87 is spaced in first axial direction AD1 from the distal end of projection 130. The chamber wall 87 is spaced in first axial direction AD1 from body mount 84. In the examples shown, each of gas channels 74a, 74b and valve bores 66a, 66b are open through chamber wall 87.

The block body 61 of valving body 60 defines various flowpaths through cartridge 14. In the example shown, each of valve bores 66a, 66b and mix chamber cavity 68 are formed within block body 61. Valve bores 66a, 66b extend into block body 61 in first axial direction AD1 and mix chamber cavity 68 extends into block body 61 in second axial direction AD2. The gas channels 74a, 74b are formed through block body 61. The projection 130 extends from the block body 61 to the second body end 96. In the example shown, chamber wall 87 forms an end of block body 61 in second axial direction AD2.

Valve bores 66a, 66b respectively include flow chambers 70a, 70b. The flow chambers 70a, 70b are fluidly connected to the manifold 18 to receive a constituent material from manifold 18. The flow valves 58a, 58b control flow of the constituent materials from the flow chambers 70a, 70b to the mix chamber 110. In the example shown, valve bores 66a, 66b respectively include gas chambers 72a, 72b. The gas chambers 72a, 72b are fluidly connected to the compressed gas flows provide to sprayer 10. The flow valves 58a, 58b control flow of compressed gas from the gas chambers 72a, 72b to the mix chamber 110. The gas chambers 72a, 72b are disposed to radially overlap with mix chamber 110 with the mix chamber 110 mounted to cartridge 14. The gas chambers 72a, 72b radially overlap with mix chamber cavity 68.

Flow chamber 70a is disposed coaxially with gas chamber 72a on valve axis VA of valve bore 66a. Flow chamber 70b is disposed coaxially with gas chamber 72b on valve axis VA of valve bore 66b.

Within each valve bore 66a, 66b, the flow chamber 70a, 70b and the gas chamber 72a, 72b of that valve bore 66a, 66b are fluidly isolated from each other by a respective valve member 88a, 88b. Valve members 88a, 88b are actuatable to fluidly connect gas chambers 72a, 72b to mix chamber 110 with sprayer 10 in the non-spray state and to fluidly connect flow chambers 70a, 70b to mix chamber 110 with sprayer 10 in the spray state.

Feed channels 134a, 134b extend between and fluidly connect valve bores 66a, 66b, respectively, with mix chamber cavity 68. Constituent materials and compressed gas flow through feed channels 134a, 134b and to mix chamber 110 to enter into mix chamber 110. In the example shown, feed channels 134a, 134b are aligned with each other such that a radial line extending from spray axis SA can extend through each feed channel 134a, 134b along a full length of the feed channel 134a, 134b without intersecting a wall defining either feed channel 134a, 134b.

Gas stem 82 extends between and fluidly connects cartridge 14 and gun body 30. Gas stem 82 is configured to route compressed gas to gas channel 74b in the example shown. Gas stem 82 extends through aperture 198 formed in coupler 90. Valve assembly 64 can move relative to the gas stem 82 as flow valves 58a, 58b are actuated between various states. Body chamber 86 is formed within valving body 60. Body chamber 86 is open in second axial direction AD2. Each of valve bores 66a, 66b open into body chamber 86. The coupler 90 of valve assembly 64 is at least partially disposed in body chamber 86 and can reciprocate within body chamber 86 during operation of sprayer 10.

Seal bodies 76a, 76b are disposed in valve bores 66a, 66b, respectively. Each seal body 76a, 76b is mounted within a respective valve bore 66a, 66b. The seal bodies 76a, 76b are configured to interface with valve members 88a, 88b, respectively, to open and close the flowpaths for the compressed gas and constituent materials to flow to mix chamber 110. In the example shown, each seal body 76a, 76b is formed as multiple components that are mounted within the valve bore 66a, 66b. It is understood, however, that not all examples are so limited. For example, the seal body 76a, 76b can be formed monolithically, among other options.

In the example shown, each seal body 76a, 76b includes a gas control body 208 that is mounted within a valve bore 66a, 66b. The gas control body 208 at least partially defines a gas chamber 72a, 72b. The gas control body 208 is configured to interface with the flow head 98 of a valve member 88a, 88b with the flow valves 58a, 58b in the second open states to seal the gas chamber 72a, 72b and prevent compressed gas flow to the mix chamber 110. The gas control bodies 208 can be considered to form the gas seats of the flow valves 58a, 58b. It is understood that gas control body 208 can be configured to directly interface with flow head 98 to seal the gas chamber 72a, 72b or gas control body 208 can support a seal element (e.g., an O-ring) that directly interfaces with the flow head 98 to seal the gas chamber 72a, 72b.

Body seal 214a is disposed about the gas control body 208 and interfaces with the gas control body 208 and with valving body 60. The body seal 214a prevents compressed gas from leaking about the exterior of the gas control body 208.

Each seal body 76a, 76b further includes a material control body 206 that is mounted within a valve bore 66a, 66b. The material control body 206 at least partially defines a flow chamber 70a, 70b. The material control body 206 is configured to interface with the flow head 98 of a valve member 88a, 88b with the flow valves 58a, 58b in the first open states to seal the flow chambers 70a, 70b and prevent constituent material from flowing to the mix chamber 110. The material control bodies 206 can be considered to form the material seats of the flow valves 58a, 58b. It is understood that material control body 206 can be configured to directly interface with flow head 98 to seal the flow chamber 70a, 70b or material control body 206 can support a seal element (e.g., an O-ring) that directly interfaces with the flow head 98 to seal the flow chamber 70a, 70b.

Body seals 214b are disposed about the material control body 206 and interface with the material control body 206 and with valving body 60. The body seals 214b prevents constituent material from leaking about the exterior of the gas control body 208. In the example shown, a pair of body seals 214b are mounted on the upstream and downstream sides of each material control body 206. The body seals 214b are disposed on opposite axial sides of the bore inlets 152a, 152b that provide constituent material to the valve bores 66a, 66b.

Body spacer 210 is disposed axially between the gas control body 208 and the material control body 206. Body spacer 210 can interface with each of gas control body 208 and material control body 206. An outlet port is formed through the body spacer 210 that is aligned with a feed channel 134a, 134b to facilitate flow from within the seal body 76a, 76b to the feed channel 134a, 134b and thus to the mix chamber cavity 68. The outlet port through body spacer 210 forms the outlet port of seal body 76a, 76b. Body fastener 212 extends through valving body 60 and interfaces with body spacer 210. Body fastener 212 secures body spacer 210 relative to valving body 60 and maintains alignment between the outlet port and the feed channel 134a, 134b. In the example shown, body fastener 212 is fixed to valving body 60 and includes a post that extends through valving body 60 to interface with body spacer 210. For example, the body fastener 212 can be connected to valving body 60 by interfaced threading, among other connection options. In the example shown, the outer body 62 extends over and covers the body fasteners 212.

Seal bodies 76a, 76b form the seats of the flow valves 58a, 58b that the movable component of the flow valves 58a, 58b (e.g., valve members 88a, 88b) move relative to, to open and close flowpaths through the flow valves 58a, 58b. In the example shown, gas control body 208 forms a gas seat that valve member 88a, 88b interfaces with to shut off gas flow to mix chamber cavity 68. In the example shown, material control body 206 forms a material seat that valve member 88a, 88b interfaces with to shut off constituent material flow to mix chamber cavity 68. In the example shown, the valve members 88a, 88b maintain sealing engagement with seal bodies 76a, 76b throughout operation, with flow valves 58a, 58b in each of the first open state, the second open state, and the closed state. In the first open state, the valve members 88a, 88b are disengaged from gas control body 208 and sealingly engaged with material control body 206. In the second open state, the valve members 88a, 88b are disengaged from material control body 206 and sealingly engaged with gas control body 208. In the closed state, the valve members 88a, 88b are sealingly engaged with gas control body 208 and with material control body 206. It is understood that the valve members 88a, 88b are considered to be sealingly engaged when directly engaged with the seal body 76a, 76b or when engaged with a separate seal (e.g., O-ring) supported by the flow head 98 or by the seal body 76a, 76b.

Retainers 78a, 78b are mounted to valving body 60. Retainers 78a, 78b are mounted at valve bores 66a, 66b, respectively. For example, each retainer 78a, 78b can mount to valving body 60 by a threaded interface, among other options. Retainers 78a, 78b are configured to retain seal bodies 76a, 76b within valve bores 66a, 66b, respectively. Shaft seals 136 are supported by retainers 78a, 78b. The shaft seal 136 is configured to engage with an exterior surface of a valve member 88a, 88b to seal with that exterior surface of the valve member 88a, 88b.

Valve assembly 64 is configured to control flow of the constituent materials and compressed gas to mix chamber 110. Valve assembly 64 is formed by valve members 88a, 88b that are mounted to coupler 90. In the example shown, each valve member 88a, 88b is formed as a shuttle that is configured to shift axially along a valve axis VA. Each valve member 88a, 88b is elongate along a respective valve axis VA. The valve members 88a, 88b are configured to slide along the respective valve axis VA and relative to the seal bodies 76a, 76b to place the flow valves 58a, 58b in the various operating states. The valve members 88a, 88b form the moving valving components of the flow valves 58a, 58b. Movement of the valve member 88a (e.g., parallel with the spray axis SA) opens and closes the flow valve 58a. Movement of the valve member 88b (e.g., parallel with the spray axis SA) opens and closes the flow valve 58b.

Each valve member 88a, 88b extends into, but not through, a valve bore 66a, 66b. The valve members 88a, 88b are at least partially disposed within the valve bores 66a, 66b, respectively. In the example shown, valve members 88a, 88b project out of the valve bores 66a, 66b in second axial direction AD2. The valve members 88a, 88b extend into body chamber 86. The valve members 88a, 88b extend to and through coupler 90 to mount to coupler 90. In the example shown, the valve members 88a, 88b project beyond the second body end 96 during at least some phases of operation of cartridge 14. In the example shown, the valve members 88a, 88b project axially outward beyond second body end 96 at least with the flow valves 58a, 58b in respective first open states.

Valve members 88a, 88b are connected to coupler 90 for simultaneous actuation along the valve axes VA. Coupler 90 is disposed coaxially with mix chamber 110 on spray axis SA. The valve members 88a, 88b interface with coupler 90 at locations radially offset from spray axis SA. The coupler 90 is configured to receive a driving input (in either axial direction AD1, AD2) along spray axis SA and transmits that driving input radially outward to valve members 88a, 88b and displaces valve members 88a, 88b axially along the respective valve axes VA. The valve members 88a, 88b are fixed to coupler 90 for simultaneous actuation such that flow valves 58a, 58b are actuated between states simultaneously and are in the same respective states. For example, the flow valves 58a, 58b will simultaneously be in the first open state, in the second open state, or the closed state.

Cartridge 14 provides significant advantages. Cartridge 14 is mountable to and dismountable from the actuator assembly 12 of sprayer 10 as a single module. The cartridge 14 includes the static components of flow valves 58a, 58b and the movable valving components of flow valves 58a, 58b. The static components (e.g., the seal bodies 76a, 76b) and the movable valving components (e.g., valve members 88a, 88b) are configured to mount to actuator assembly 12 and dismount from actuator assembly 12 as part of cartridge 14. The cartridge 14 does not itself include driving components that provide mechanical force to actuate flow valves 58a, 58b. The cartridge 14 does not include any driver, similar to drive piston 46. Instead, the mechanical forces are input to cartridge 14 at coupler 90 and transmitted to valve members 88a, 88b. The cartridge 14 does not support trigger 24. The cartridge 14 does not include a valve that reroutes compressed gas to different flowpaths like gas valve 44; instead, the flow valves 58a, 58b can turn on and turn off the flow of the compressed gas to mix chamber cavity 68. Constituent material and compressed gas flow in a single direction through cartridge 14, which is to mix chamber cavity 68. Valving body 60 is open in second axial direction AD2 to facilitate mounting of cartridge 14 to actuator assembly 12 at static interface 126 and dynamic interface 128.

The cartridge 14 being mountable and dismountable as a single unit allows for dismounting and removal of the portions of sprayer 10 that control flow of constituent materials and in which constituent materials mix to form the plural component material. The cartridge 14 is dismountable from the actuator assembly 12 that directs flows of compressed gas and from the manifold 18 that directs flows of constituent material. The cartridge 14 isolates any potential cross-over flow to locations within cartridge 14, preventing contamination in the event of cross-over. The cartridge 14 further includes various check valves that prevent retrograde flow (e.g., inlet checks 150a, 150b (FIG. 4B) and gas checks 80a (FIGS. 6B), 80b). Such valving isolates any potential cross-over to within cartridge 14. Cartridge 14 can be removed and replaced with a new cartridge 14 in the event of such undesired curing in cartridge 14, reducing downtime and providing cost savings. The user can utilize the same manifold 18 and actuator assembly 12 and simply swap cartridges 14.

FIG. 8A is an isometric view of cartridge 14 from a rear side of cartridge 14. FIG. 8B is an enlarged isometric view of cartridge 14 from a rear side of cartridge 14 with gas stem 82 removed for clarity. FIG. 8C is an enlarged isometric view of a portion of actuator assembly 12. FIGS. 8A-8C are discussed together with continued reference to FIGS. 1A-7C.

Actuator assembly 12 and cartridge 14 of sprayer 10 are shown. Gun body 30 and drive piston 46 of actuator assembly 12 are shown. Housing 32, housing mount 56, receiver 132, and body slot 178 of gun body 30 are shown. Valving body 60, outer body 62, valve assembly 64, cartridge inlets 148a, 148b; body mount 84, and projection 130 of cartridge 14 are shown. Valve members 88a, 88b; coupler 90, and valve mount 92 of valve assembly 64 are shown.

Cartridge 14 is mountable to and dismountable from actuator assembly 12 as a single unit. Cartridge 14 is configured to mount to actuator assembly 12 via a static interface 126 (best seen in FIGS. 2A and 2B) and a dynamic interface 128 (best seen in FIGS. 2A and 2B). The static interface 126 remains fixed when coupled and braces moving components. The static interface 126 fixes valving body 60 to gun body 30 such that cartridge 14 is supported by gun body 30. The dynamic interface 128 allows the transfer of mechanical motion between the actuator assembly 12 and the cartridge 14, such as to open and close flow valves 58a, 58b. Both the static interface 126 and the dynamic interface 128 can be formed and broken for connecting the cartridge 14 to and removing the cartridge 14 from the actuator assembly 12. The static interface 126 and dynamic interface 128 can be simultaneously formed during mounting of cartridge 14 and can be simultaneously broken during dismounting of cartridge 14. In the example shown, the static interface 126 and the dynamic interface 128 are disposed coaxially on spray axis SA with cartridge 14 mounted to actuator assembly 12.

Static interface 126 is formed by projection 130 of valving body 60 interfacing with receiver of gun body 30. In the example shown, the projection 130 includes body mount 84 of valving body 60 and is part of the cartridge 14. Projection 130 can be formed as a cylindrical projection, among other options. In the example shown, the receiver 132 is formed by housing mount 56 and is part of the gun body 30. It is understood, however, that in alternative examples, the projection 130 of cartridge 14 can be configured to receive the receiver 132 of gun body 30, such that cartridge 14 can be considered to include a receiver and gun body 30 can be considered to include a projection. In such an example, a portion of gun body 30 can extend into the projection 130 of cartridge 14 to be disposed at least partially within the valving body 60.

Body mount 84 is formed by a series of cartridge tabs 216 that project radially outward from the valving body 60. The cartridge tabs 216 are arrayed about the spray axis SA. In the example shown, the cartridge tabs 216 are evenly arrayed about the spray axis SA. The cartridge tabs 216 include alignment cartridge tab 216a and mount cartridge tabs 216b. The circumferential width CW1 of alignment cartridge tab 216a differs from the circumferential width CW2 of the mount cartridge tabs 216b. In the example shown, the circumferential width CW1 of alignment cartridge tab 216a is narrower than the circumferential width CW2 of the mount cartridge tabs 216b. The circumferential widths are taken between the circumferential edges of a cartridge tab 216 and along the radially outer surface of the cartridge tab 216. The varying circumferential widths of alignment cartridge tab 216a and mount cartridge tabs 216b provides a keyed interface between body mount 84 and housing mount 56 that allows for cartridge 14 to be mounted in a single orientation relative to gun body 30, in the example shown. Cartridge tabs 216 are formed at second body end 96 of valving body 60 in the example shown.

Housing mount 56 is configured to interface with body mount 84 to form the static interface 126. In the example shown, housing mount 56 is formed by a series of body notches 218 and body tabs 220 that extend about the spray axis SA. The body notches 218 extend radially outward such that the body tabs 220 are formed between circumferentially adjacent ones of the body notches 218. Each body tab 220 extends only partially about the spray axis SA. Each body notch 218 extends only partially about the spray axis SA. The body notches 218 include alignment body notch 218a and mount body notches 218b. The circumferential width CW3 of alignment body notch 218a differs from the circumferential width CW4 of the mount body notch 218b. In the example shown, the circumferential width CW3 of alignment body notch 218a is narrower than the circumferential width CW4 of the mount body notches 218b. The circumferential widths are taken between the circumferential edges of a body notch 218 and along the radially outer surface of the body notch 218. The varying circumferential widths of alignment body notch 218a and mount body notches 218b provides a keyed interface between body mount 84 and housing mount 56 that allows for cartridge 14 to be mounted in a single orientation relative to gun body 30, in the example shown. Body notches 218 and body tabs 220 are formed at the distal end of gun body 30 in first axial direction AD1 in the example shown.

While alignment cartridge tab 216a is described as having a narrower width than mount cartridge tabs 216b, it is understood that not all examples are so limited. For example, cartridge 14 can include an alignment cartridge tab 216a having a greater circumferential width that mount cartridge tabs 216b. In such an example, the alignment body notch 218a would correspondingly have a greater circumferential width than the mount body notches 218b.

During mounting, the alignment cartridge tab 216a is aligned axially with the alignment body notch 218a. The circumferential width CW2 of a mount cartridge tab 216b is larger than the circumferential width CW3 of the alignment body notch 218a such that a mount cartridge tab 216b cannot pass through the alignment body notch 218a during mounting. If a mount cartridge tab 216b is aligned with alignment body notch 218a during mounting, the body tabs 220 that bracket the alignment body notch 218a will prevent the mount cartridge tab 216b from passing through the alignment body notch 218a, preventing mounting of cartridge 14 in such an orientation. While the alignment

With alignment cartridge tab 216a axially aligned with alignment body notch 218a, the cartridge 14 is shifted in second axial direction AD2 such that the cartridge tabs 216 pass through the body notches 218. The cartridge tabs 216 are thus located within the receiving chamber 222 formed in gun body 30. Receiving chamber 222 is open in first axial direction AD1 towards the mix chamber 110. The mix chamber 110 does not extend into the receiving chamber 222 and does not radially overlap with portions of gun body 30.

With cartridge tabs 216 passed through body notches 218 the projection 130 radially overlaps with the receiver 132. The valving body 60 is disposed within the gun body 30 to radially overlap with the gun body 30. The cartridge 14 can be rotated, such as on the spray axis SA, relative to the gun body 30 (or the gun body 30 can be rotated relative to the cartridge 14) to misalign the cartridge tabs 216 with the body notches 218 to lock the cartridge 14 to the gun body 30. Relative rotation between the cartridge 14 and the gun body 30 disposes the cartridge tabs 216 to axially overlap with the body tabs 220. The body tabs 220 axially overlapping with the cartridge tabs 216 blocks axial movement of the cartridge tabs 216, and thus of the cartridge 14, in first axial direction AD1.

To dismount the cartridge 14, the cartridge 14 is be rotated, such as on the spray axis SA, to realign the cartridge tabs 216 with the body notches 218 before the body mount 84 is able to be moved out of the receiving chamber 222. For example, the cartridge 14 can be rotated in an opposite rotational direction from the rotation used to mount cartridge 14. Alignment cartridge tab 216a is realigned with alignment body notch 218a and cartridge 14 can be pulled in first axial direction AD1, breaking the static interface 126 and dismounting cartridge 14 from gun body 30. It is understood that various other locking features are possible to a static connection between cartridge 14 and gun body 30. It is noted that the cartridge 14 is not threaded to the gun body 30 in this embodiment, and that only a partial turn, such as a quarter turn, but not a full turn or even half a turn, mounts the cartridge 14 to the gun body 30, but not all embodiments are so limited.

The dynamic interface 128 includes valve mount 92 interfacing with drive mount 54. This interfacing can also be in the form of a projection and receiver as previously described, with or without tabs and grooves. In the example shown, the valve assembly 64 forms a receiver and the drive piston 46 forms a projection that extends into the receiver of the valve assembly 64. It is understood, however, that in various other examples the drive piston 46 can receive a portion of valve assembly 64 such that valve assembly 64 extends into drive piston 46 to form the dynamic interface 128.

Drive mount 54 is supported by drive piston 46. Drive mount 54 can be formed monolithically with drive piston 46, such as with piston shaft 50, or can be formed separately from drive piston 46 and connected to drive piston 46.

Valve mount 92 is formed on valve assembly 64. Valve mount 92 is formed on coupler 90 in the example shown. In the example shown, valve mount 92 is disposed coaxially with body mount 84 on spray axis SA.

In the example shown, drive mount 54 includes drive tabs 224, groove 226, and drive brace 228. Drive tabs 224 project radially outward from piston shaft 50. In the example shown, the drive mount 54 includes a series of drive tabs 224 that project radially outward. The drive tabs 224 are arrayed annularly about the spray axis SA. Drive brace 228 is spaced in second axial direction AD2 from drive tabs 224. Drive brace 228 is formed as a surface that is oriented in first axial direction AD1. Groove 226 is disposed axially between drive tabs 224 and drive brace 228.

In the example shown, valve mount 92 includes valve notches 230 and valve tabs 232. The valve notches 230 are disposed annularly about the spray axis SA and are interspersed between the valve tabs 232. Valve tabs 232 are disposed between adjacent ones of the valve notches 230. The valve notches 230 are sized to allow the drive tabs 224 to pass axially through the valve notches 230 during mounting and dismounting of the cartridge 14 on the gun body 30. Valve mount 92 is disposed around aperture 198 that extends fully axially through coupler 90 in the example shown. It is understood, however, that not all examples are so limited. For example, aperture 198 can be open in second axial direction AD2 and closed in first axial direction AD1, such as in examples in which each gas channel 74a, 74b receives compressed gas from body chamber 86 or in examples including a single gas channel receiving compressed gas from body chamber 86.

In the example shown, the valve notches 230 are oriented in the same radial directions as the cartridge tabs 216. Similarly, the drive tabs 224 are oriented in the same radial directions as the body notches 218. Such radial directionality of the interface components facilitates simultaneous formation and breaking of the static interface 126 and the dynamic interface 128 during mounting of the cartridge 14 on and dismounting of the cartridge 14 from the actuator assembly 12.

During mounting, axially aligning the alignment cartridge tab 216a with alignment body notch 218a also axially aligns the valve notches 230 with the drive tabs 224. Drive tabs 224 pass through valve notches 230 as cartridge tabs 216 pass through the housing body notches 218. The relative rotation between cartridge 14 and gun body 30 also causes relative rotation between valve assembly 64 and drive piston 46. Such relative rotation causes the valve notches 230 to shift relative to drive tabs 224 to be misaligned with the drive tabs 224. Relative rotation between the cartridge 14 and the drive piston 46 disposes the drive tabs 224 to axially overlap with the valve tabs 232. The valve tabs 232 also axially overlap with the drive brace 228. The valve tabs 232 are disposed at least partially within groove 226 and are axially bracketed between the drive tabs 224 and the drive brace 228.

Once the dynamic interface 128 is engaged, the drive mount 54 can linearly displace the coupler 90 via the valve mount 92. For example, drive tabs 224 can exert force on valve tabs 232 in second axial direction AD2 to displace valve assembly 64 in second axial direction AD2, while the drive brace 228 can exert force on valve tabs 232 in first axial direction AD1 to displace valve assembly 64 in first axial direction AD1.

Movement of the drive piston 46 in the first axial direction AD1 (the downstream direction) displaces coupler 90 in first axial direction AD1 and coupler 90 exerts driving force on valve members 88a, 88b to displace the valve members 88a, 88b in the first axial direction AD1. Displacing the valve members 88a, 88b in the first axial direction AD1 actuates the flow valves 58a, 58b to respective second open states, fluidly connecting the flow chambers 70a, 70b with the mix chamber 110 and allowing flow of the A and B constituent materials to mix chamber 110 while also closing off flow of compressed gas to mix chamber 110. Movement of the drive piston 46 in the second axial direction AD2 (the upstream direction) displaces coupler 90 in second axial direction AD2 and coupler 90 exerts driving force on valve members 88a, 88b to displace valve members 88a, 88b in second axial direction AD2. Displacing the valve members 88a, 88b in second axial direction AD2 actuates the flow valves 58a, 58b back to respective first open states, fluidly connecting the gas chambers 72a, 72b to mix chamber 110 to resume the flow of purge gas while shutting off flow of the A and B constituent materials to mix chamber 110. The driving mechanical motion is conveyed from the drive piston 46 to the valve members 88a, 88b via the coupler 90.

It is noted in some embodiments that the linear motion which is generated in the actuator assembly 12 and then conveyed through the dynamic interface 128 into the cartridge 14 may be generated electrically (e.g., by solenoid or other electric actuator), hydraulically by liquid under pressure, or mechanically via trigger pull and release (e.g., trigger mechanically displacing the drive mount 54 in the first axial direction AD1 and a spring mechanically displacing the drive mount 54 in second axial direction AD2, instead of or in addition to pneumatic actuation. Various other types of dynamic and static interfaces are possible to both secure the cartridge 14 and convey mechanical motion to open and close the flow valves 58a, 58b.

In the example shown, the projections and receivers forming the static interface 126 and the dynamic interface 128 are disposed in opposite configurations. The static interface 126 is formed between a portion of the cartridge 14 disposed within and received by a portion of the actuator assembly 12. In the example shown, a portion of the valving body 60 extends into and interfaces with a portion of the gun body 30 to form the static interface. The dynamic interface 128 is formed between a portion of the actuator assembly 12 disposed within and received by a portion of the cartridge 14. In the example shown, a portion of the drive piston 46 extends into and interfaces with a portion of the valve assembly 64. It is understood, however, that not all examples are so limited. In some examples, the projections can both be formed on the cartridge 14 and receivers both formed on the actuator assembly 12 such that portions of the cartridge 14 are received in portions of the actuator assembly 12 to form both the static interface 126 and the dynamic interface. In some examples, the receivers can both be formed on the cartridge 14 and projections both be formed on the actuator assembly 12 such that portions of the actuator assembly 12 are received in portions of the cartridge 14 to form both the static interface and the dynamic interface. In some examples, portions of the actuator assembly 12 extend into portions of the cartridge 14 to form the static interface 126 while portions of the cartridge 14 extend into portions of the actuator assembly 12 to form the dynamic interface 128.

In the example shown, the valve assembly 64 is keyed to valving body 60. More specifically, coupler 90 is keyed to valving body 60. Valve assembly 64 can be considered to form a dynamic component of cartridge 14 while valving body 60 and other portions of cartridge 14 form one or more static components of cartridge 14. The dynamic valve assembly 64 is keyed to the valving body 60. In the example shown, the coupler 90 is keyed to valving body 60. Specifically, the radially exterior surface of coupler 90 is non-circular to mate with the non-circular radially inner surface of the projection 130 of the valving body 60 defining body chamber 86. In the example shown, the exterior surface of the coupler 90 is curved with a flat portion and the interior surface defining the body chamber 86 is similarly curved with a flat portion. The flat portions radially overlap and can interface to prevent relative rotation. In the example shown, the exterior of the coupler 90 and the interior surface of valving body 60 defining body chamber 86 are D-shaped. It is understood that coupler 90 and body chamber 86 can be of any desired interfacing shapes that prevent relative rotation, such as hexed, square, triangular, trapezoidal, oval, among other options.

The keyed interface rotationally locks the valve assembly 64 relative to the valving body 60 to provide simultaneous rotation. Such a keyed interface can protect valve members 88a, 88b and other portions of the flow valves 58a, 58b from damage that can be caused by relative rotation. The valve members 88a, 88b extends into valve bores 66a, 66b and are fixed to coupler 90. If the valve assembly 64 was at an incorrect axial portion such that valve tabs 232 were circumferentially aligned with the drive tabs 224 when the cartridge 14 is rotated relative to the gun body 30 to form the static interface 126 connection, then such rotation could exert torque on valve members 88a, 88b that could bend or otherwise deform valve members 88a, 88b. The keyed interface prevents rotation of the valving body 60 relative to the valve assembly 64 about the spray axis SA.

Rotationally locking the valve assembly 64 relative to the valving body 60 facilitates simultaneous formation of the static interface 126 connection and the dynamic interface 128 connection. During mounting, the cartridge 14 is aligned with receiving chamber 222 of gun body 30. In the example shown, both the static interface 126 and the dynamic interface 128 are formed by relative rotation between the cartridge 14 and the actuator assembly 12. If the valving body 60 could rotate relative to the valve assembly 64, then the connection may not be formed at the dynamic interface 128 and/or the dynamic interface 128 may remain connected when disconnecting the static interface 126. In the example shown, the valving body 60 can torque the coupler 90 as the valving body 60 is rotated to form or break the static interface 126. Preventing relative rotation facilitates simultaneous formation and breaking of the static interface 126 and the dynamic interface 128.

As discussed above, the manifold 18 can be mounted to cartridge 14 and can lock cartridge 14 on gun body 30 to inhibit relative rotation therebetween. FIG. 8C shows body slot 178 formed on a lower side of gun body 30. In the example shown, body slot 178 is formed in housing 32. Body slot 178 is formed on a lower side of housing 32. Body slot 178 is formed on the same side of housing 32 that handle 34 projects from. Body slot 178 is configured to receive the manifold brace 172 that projects from manifold body 166. The manifold brace 172 being disposed in body slot 178 prevents manifold 18 from moving circumferentially about the spray axis SA and relative to gun body 30. With manifold 18 fixed to cartridge 14 (e.g., by fastener 20) the cartridge 14 is also prevented from rotating about the spray axis SA due to the rotation lock interface between manifold 18 and gun body 30. The connection interfaces between actuator assembly 12 and cartridge 14 provide significant advantages. The cartridge 14 is mountable by less than a full relative rotation between cartridge 14 and actuator assembly 12. The cartridge 14 is not threaded on the gun body 30 which would require multiple full rotations to form the static interface 126. Such a threading interface can lead to misalignment when forming the dynamic interface 128, increasing the complexity of sprayer 10 and the connection of cartridge 14. The static interface 126 and dynamic interface 128 can be considered to form dual projection-receiver connections.

The dynamic interface 128 connection and the static interface 126 connection are configured to be formed simultaneously. Both connections are formed by relative axial movement between cartridge 14 and actuator assembly 12 and relative rotational movement between cartridge 14 and actuator assembly 12. Both connections are broken by relative rotational movement between cartridge 14 and actuator assembly 12 and relative axial movement between cartridge 14 and actuator assembly 12. Simultaneously forming the dynamic and static connections provides for quick, efficient, and simple mounting and dismounting of cartridge 14. A user can easily dismount a cartridge 14 and mount the same or a different cartridge 14 on actuator assembly 12 while minimizing downtime, providing for more efficient spray operations.

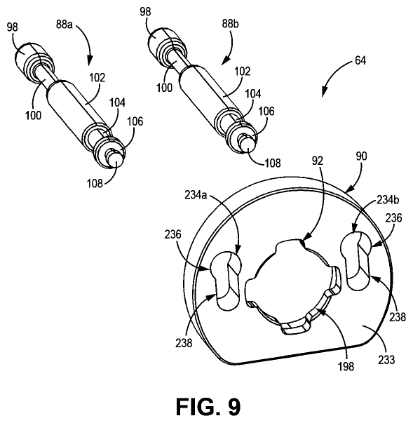

FIG. 9 is an exploded view of valve assembly 64 showing the interface between valve members 88a, 88b and coupler 90. FIG. 9 is discussed with continued reference to FIGS. 1A-8C. Valve assembly 64 includes valve members 88a, 88b, coupler 90, and valve mount 92. Coupler 90 includes mount slots 234a, 234b. Each mount slot 234a, 234b includes receiving aperture 236 and retaining slot 238. Each valve member 88 includes flow head 98, flow neck 100, valve member body 102, mount neck 104, mount head 106, and tail 108.

Valve assembly 64 forms a dynamic component of cartridge 14 that is configured to move relative to the valving body 60 during operation. The valve assembly 64 controls the flow valves 58a, 58b between the respective first open state, second open state, and closed state.

Coupler 90 is configured to connect with a driving component of the actuator assembly 12 (e.g., drive piston 46) to receive a mechanical input that displaces coupler 90 along an axis (e.g., spray axis SA). Valve mount 92 is formed by coupler 90. Valve mount 92 is disposed about aperture 198 through coupler 90. Mount slots 234a, 234b are formed in coupler body 233 of coupler 90. In the example shown, the mount slots 234a, 234b extend fully through coupler body 233 and are open in first axial direction AD1 and second axial direction AD2. In the example shown, each mount slot 234a, 234b extends through a first face of coupler body 233 oriented in axial direction AD1 and a second face of coupler body 233 oriented in second axial direction AD2. Each mount slot 234a, 234b includes a receiving aperture 236 and a retaining slot 238 that extends from the receiving aperture 236. The receiving apertures 236 are wider than the retaining slots 238. The wider receiving aperture 236 facilitate valve members 88a, 88b passing through the mount slots 234a, 234b to align for mounting on the coupler 90. The narrower retaining slots 238 connect the valve members 88a, 88b to the coupler 90 such that coupler 90 can exert driving forces on the valve members 88a, 88b to displace the valve members 88a, 88b in either axial direction AD1, AD2.

The flow head 98 is configured to interface with a seal body 76a, 76b (e.g., either directly with the seal body 76a, 76b or indirectly via a seal disposed between flow head 98 and seal body 76a, 76b) to control flows of constituent materials and compressed gas to mix chamber 110. The flow neck 100 extends between and connects the flow head 98 and the member body 102. The flow neck 100 has a smaller diameter than the flow head 98. Member body 102 extends axially between flow neck 100 and mount neck 104. Member body 102 has a larger diameter than flow neck 100 in the example shown. Mount neck 104 extends axially between member body 102 and mount head 106. Mount neck 104 is configured to extend axially through coupler 90. Mount neck 104 is configured to be disposed within mount slot 234a, 234b to mount valve member 88a, 88b to coupler 90. Mount head 106 is disposed at an opposite axial end of mount neck 104 from member body 102. In the example shown, valve member 88a, 88b includes tail 108 that extends axially from the mount head 106. The tail 108 projects axially away from mount neck 104 and is disposed on an opposite axial side of mount head 106 from mount neck 104. Tail 108 is configured to provide a tool interface that facilitates removal of valve assembly 64 from cartridge 14, such as for cleaning or replacement.

Mount neck 104 has a smaller diameter than member body 102 and mount head 106. The larger diameters of valve member body 102 and mount head 106 relative to mount neck 104 facilitate coupler 90 transmitting driving forces to valve member 88a, 88b to displace valve member 88a, 88b in either first axial direction AD1 or second axial direction AD2. The coupler 90 exerts an axial driving force on member body 102 to displace valve member 88a, 88b in first axial direction AD1. The coupler 90 exerts an axial driving force on mount head 106 to displace valve member 88a, 88b in second axial direction AD2.

To assemble a valve member 88a, 88b to coupler 90, the valve member 88a, 88b is passed through the receiving aperture 236 such that mount neck 104 is disposed in receiving aperture 236 and aligned with retaining slot 238. The valve member 88a, 88b is then shifted relative to coupler 90 (or the coupler 90 shifted relative to valve member 88a, 88b) such that the mount neck 104 is disposed within retaining slot 238. With mount neck 104 disposed in retaining slot 238, the mount head 106 and valve member body 102 axially overlap with the body of coupler 90. The coupler 90 can then exert axial driving force on the member body 102 to displace valve member 88a, 88b in the first axial direction AD1 and exert axial driving force on the mount head 106 to displace valve member 88 in the second axial direction AD2.

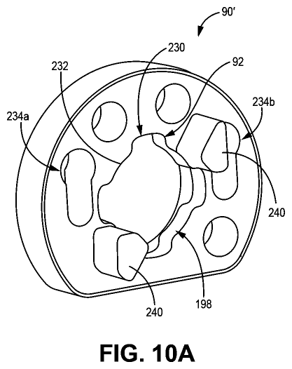

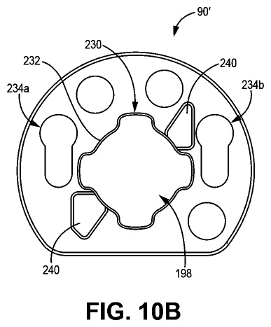

FIG. 10A is an isometric view of a coupler 90′. FIG. 10B is an elevation view of a rear side of coupler 90′. FIGS. 10A and 10B are discussed together and with continued reference to FIGS. 1A-9. Coupler 90′ is substantively similar to coupler 90, except that coupler 90′ includes rotation locks 240. Rotation locks 240 project from the face of coupler 90′ oriented in second axial direction AD2. Each rotation lock 240 is formed as a discrete projection that extends in second axial direction AD2. The rotation locks 240 are disposed circumferentially between valve notches 230 of coupler 90′. At least a portion of each rotation lock 240 extends from a valve tab 232. Rotation locks 240 can be considered to axially overlap with a valve tab 232.

Rotation locks 240 are configured to ensure formation of the dynamic interface 128 when forming the static interface 126 between cartridge 14 and actuator assembly 12. For example, valve assembly 64 may be displaced fully in first axial direction AD1 when attempting to mount cartridge 14 to actuator assembly 12. However, the drive piston 46 in displaced in second axial direction AD2 such that sprayer 10 is meant to be in a non-spray state on initial mounting. The valve assembly 64 being forward and drive piston 46 being rearward can create an axial gap between valve mount 92 and drive mount 54 such that static interface 126 can be formed but the dynamic interface 128 is not formed. In such an example, initiating flow of plural constituent material to cartridge 14 will cause the plural constituent material to flow to and mix within mix chamber 110, but with the dynamic connection not formed the flows of constituent material cannot be shut off.

Rotation locks 240 extend from coupler 90′ and are configured to extend into the gaps circumferentially between drive tabs 224 in the event the valve assembly 64 is forward and drive piston 46 is rearward during mounting. Rotation locks 240 circumferentially overlapping with drive tabs 224 prevents cartridge 14 from being rotated on spray axis SA to form the static connection. Such rotational resistance informs the user that the valve assembly 64 needs to be displaced in second axial direction AD2 (e.g., by grasping a tail 108 with a tool, such as pliers, or by grasping coupler 90′ through aperture 198, among other options). The rotation locks 240 do not inhibit rotation of cartridge 14 when drive mount 54 and valve mount 92 are aligned for forming the dynamic interface 128. While coupler 90′ is described as including rotation locks 240, it is understood that not all examples are so limited. For example, cartridge 14 and actuator assembly 12 can be sized such that drive tabs 224 circumferentially overlap with valve tabs 232 when valve assembly 64 is fully forward and drive piston 46 is fully rearward, which interface also prevents formation of the static interface 126 when the drive mount 54 and valve mount 92 are not aligned to form the dynamic interface 128.

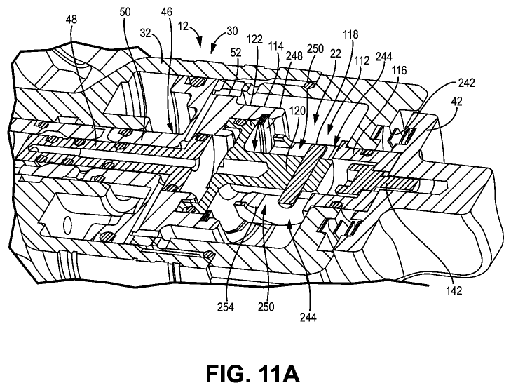

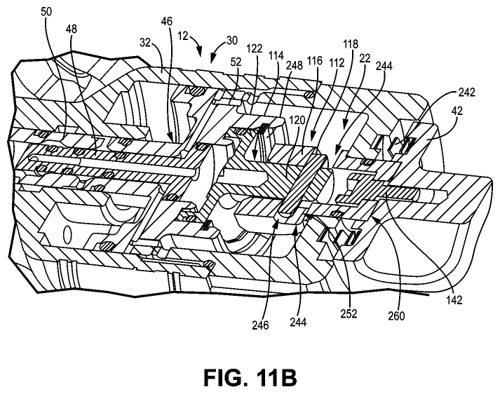

FIG. 11A is a partial cross-sectional view taken along line 11-11 in FIG. 1A showing shutoff 22 in an unlocked state. FIG. 11B is a partial cross-sectional view similar to FIG. 11A but showing the shutoff 22 in a locked state. FIGS. 11A and 11B are discussed together with continued reference to FIGS. 1A-10B. Gun body 30, shutoff 22, drive piston 46, and dose piston 48 of sprayer 10 are shown. Shutoff 22 includes knob 42, converter 112, connector 114, shutoff fastener 142, and spring 242. Converter 112 includes positioner 118 and converter body 116. Converter body 116 includes lock slots 244. Connector 114 includes connector shaft 120 and connector head 122.

Shutoff 22 is connected to drive piston 46 and is configured to control operability of drive piston 46, thereby controlling whether sprayer 10 can be actuated to the spray state. Shutoff 22 is connected to valve assembly 64 via drive piston 46. Shutoff 22 is supported by gun body 30. Shutoff 22 is configured such that shutoff 22 can actuate valve assembly 64 in second axial direction AD2 away from spray orifice 28 of mix chamber 110. Shutoff 22 can actuate valve assembly 64 in second axial direction AD2 to place each flow valve 58a, 58b in respective first open states in which the flows of the A and B constituent materials to mix chamber 110 are blocked such that sprayer 10 does not emit plural component material.

Knob 42 is disposed outside of gun body 30 and is accessible from an exterior of sprayer 10. Knob 42 is accessible by a user to actuate shutoff 22 between the locked and unlocked states. Knob 42 is configured to be rotated on spray axis SA to actuate shutoff 22 between the locked and unlocked states.

Spring 242 is disposed between knob 42 and gun body 30. Spring 242 is configured to bias knob 42 in second axial direction AD2 and away from gun body 30. Spring 242 can cause positioner 118 to enter into a detent 246 in the lock slot 244 of converter 112 to maintain shutoff 22 in the locked state, as discussed in more detail below.

Connector 114 is connected to drive piston 46. Connector head 122 is disposed at least partially within piston head 52 of drive piston 46 in the example shown. Connector 114 is retained within the cavity of piston head 52 by retainer 248. Retainer 248 is mounted to drive piston 46 and is configured to prevent connector 114 from moving in second axial direction AD2 relative to drive piston 46. Retainer 248 can be formed as a full ring that extends fully about the spray axis SA or can be formed as one or more partial rings extending partially about spray axis SA. Connector shaft 120 extends in second axial direction AD2 away from drive piston 46. Connector shaft 120 extends into converter body 116 to radially overlap with portions of converter body 116.

Converter 112 is operably connected to connector 114 and to knob 42. Converter 112 is operably connected to connector 114 such that converter 112 can displace connector 114 axially along the spray axis SA in second axial direction AD2. Converter 112 is further operably connected to connector 114 such that converter can prevent connector 114, and thus drive piston 46, from shifting in first axial direction AD1. With shutoff 22 in the unlocked state (FIG. 11A) the connector 114 is able to move axially relative to the converter body 116. With shutoff 22 in the locked state (FIG. 11B) the connector 114 is held in a fixed position along spray axis SA such that sprayer 10 is prevented from being actuated to the spray state.

Converter 112 is configured to translate a rotational input from knob 42 into a linear input to connector 114. Converter 112 is configured to convert the rotational input from knob 42 into axial movement of connector 114 along spray axis SA to actuate drive piston 46 from a forward position associated with the spray state of sprayer 10 to a rearward position associated with a non-spray state of sprayer 10.

Positioner 118 is supported by connector 114. In the example shown, the positioner 118 is supported by connector shaft 120. The positioner 118 extends through connector shaft 120 in the example shown. Positioner 118 extends radially outward from connector shaft 120. Positioner 118 is configured to interface with converter body 116. In the example shown, positioner 118 extends into lock slots 244 formed in converter body 116. Positioner 118 forms a linear displacer of converter 112.

Converter body 116 is connected to knob 42 by shutoff fastener 142. Shutoff fastener 142 fixes converter 112 and knob 42 together. Converter body 116 is connected to knob 42 for simultaneous rotation, such that rotating knob 42 causes rotation of converter body 116. In the example shown, converter body 116 is disposed coaxially with spray axis SA and is configured to rotate on spray axis SA. Converter body 116 forms a rotational input of converter 112.

Lock slots 244 are formed in converter body 116. In the example shown, each lock slot 244 extend fully through converter body 116 between an outer radial surface of converter body 116 and an inner radial surface of converter body 116. In the example shown, the lock slots 244 extend helically about the spray axis SA. Lock slots 244 extend between free end 250 and lock end 252. The free end 250 has a greater axial length than the lock end 252. The positioner 118 is able to move axially relative to converter body 116 when disposed at free end 250 and the positioner 118 is restrained from moving axially when disposed at lock end 252.

The lock slot 244 includes a ramped surface 254 that is configured to interface with the positioner 118 to displace positioner 118 axially. The ramped surface 254 exerts driving force on the positioner 118 to displace positioner 118 in second axial direction AD2.

The positioner 118 can comprise a pin, knob, or other projection that interfaces with a helical structure (e.g., lock slots 244) of the converter body 116. The helical lock slots 244 can wrap partially or fully around the axis, amongst other options. In the example shown, the lock slots 244 do not extend fully about the spray axis SA. The positioner 118 may be fixed to only be able to translate linearly along the spray axis SA, such that interfacing with the rotating helical structure of converter body 116 causes the pin, knob, or other projection forming positioner 118 to move linearly along the axis. It is understood that, while positioner 118 is connected to connector 114 in the example shown, the positioner 118 can be connected directly or indirectly with the drive piston 46, which drive piston 46 is indirectly connected to the valve members 88a, 88b via coupler 90.

Shutoff 22 is actuatable between a locked state and an unlocked state. To actuate shutoff 22 from the unlocked state to the locked state the knob 42 is rotated in a first rotational direction (e.g., one of clockwise and counterclockwise) on spray axis SA. Rotating the knob 42 rotates the converter body 116 in the same rotational direction as the knob 42. The converter body 116 is rotated relative to the positioner 118 to position the positioner 118 within the lock ends 252 of the lock slots 244. With the positioner 118 at the lock ends 252 of the lock slots 244, the converter body 116 blocks axial movement of the positioner 118 in first axial direction AD1. The positioner 118 interfacing with the converter body 116 prevents the connector 114, which is fixed to positioner 118, from moving in the first axial direction AD1, which prevents drive piston 46 and thus valve assembly 64 from moving in the first axial direction AD1. Sprayer 10 is thereby locked in the non-spray state.

With shutoff 22 in the locked state, the positioner 118 is disposed at lock end 252 of lock slot 244 and is prevented from moving in first axial direction AD1. The positioner 118 is connected to the connector 114 such that the connector 114 is prevented from moving in first axial direction AD1. The connector 114 is connected to the drive piston 46 such that drive piston 46 is prevented from moving in first axial direction AD1. As such, the drive piston 46 is prevented from actuating the valve assembly 64, and sprayer 10 is locked in the non-spray state.

To actuate shutoff 22 from the locked state to the unlocked state, knob 42 is rotated in a second rotational direction (e.g., the other one of clockwise and counterclockwise) on the spray axis SA. The converter body 116 rotates in the same rotational direction as the knob 42. The converter body 116 is rotated relative to the positioner 118 to position the positioner 118 within the free ends 250 of the lock slots 244. With the positioner 118 at the free ends 250 of the lock slots 244, the converter body 116 does not blocks axial movement of the positioner 118 in first axial direction AD1. The drive piston 46 is thus able to move in first axial direction AD1 to actuate the valve assembly 64 and place sprayer 10 in the spray state.

With shutoff 22 in the unlocked state (FIG. 11A) the positioner 118 is disposed at free end 250 of lock slot 244 and is able to move axially within lock slot 244. The positioner 118 is able to move axially relative to converter body 116. With positioner 118 axially movable relative to converter body 116, the connector 114 can move axially and the drive piston 46 can move axially. The drive piston 46 can move in first axial direction AD1 along spray axis SA such that sprayer 10 can be actuated from the non-spray state to the spray state. The drive piston 46 can also move in second axial direction AD2 along spray axis SA such that sprayer 10 can be actuated from the spray state to the non-spray state.

In the example shown, the mechanical motion to move valve members 88a, 88b comes from pneumatic operation initiated from the trigger 24. In a rare event, however, air pressure (or hydraulic pressure in examples including hydraulic actuation) may be lost while sprayer 10 is in the spray state and spraying, thus requiring quick manual shut off of the A and B constituent material flows to cease spraying of the plural component material due to the trigger 24 not being able to move drive piston 46 pneumatically (or hydraulically). Such motion is provided by the shutoff 22. The shutoff 22 attaches to drive piston 46 and can displace drive piston 46 in second axial direction AD2 to pull the valve members 88a, 88b rearward to close flow valve 58a to shut off the component A flow to mix chamber 110 and close the flow valve 58b to shut off the component B flow to mix chamber 110.

In the case of the loss of pneumatic (or hydraulic) flow, knob 42 is rotated by the user. The knob 42 causes rotation of the converter body 116. Converter body 116 rotates on spray axis SA and the ramped surfaces 254 interface with positioner 118 and displace positioner along the ramped surfaces 254. The positioner 118 displaces linearly in second axial direction AD2 as the converter body 116 is rotated. The positioner 118 is driven along the ramped surface to the lock end 252 of the lock slot 244. The positioner 118 moves in second axial direction AD2 as the positioner 118 is displaced along the ramped surface 254.

The positioner 118 draws connector 114 in second axial direction AD2 and connector 114 draws drive piston 46 in second axial direction AD2. The drive piston 46 draws valve assembly 64 in second axial direction AD2 to shut off the flow of the A and B constituent materials to the mix chamber 110, thereby shutting off the spray of the plural component material. Shutoff 22 can thereby actuate the sprayer 10 from the spray state to the non-spray state in the event of pneumatic (or hydraulic) pressure loss.

Knob 42 is accessible by the user to actuate shutoff 22. Actuation of the knob 42 provides mechanical input to converter 112. In this embodiment, the converter 112 converts rotational motion to linear motion. More specifically, the knob 42 can be turned, providing rotational input to the converter 112. The converter 112 displaces connector 114 axially in second axial direction AD2 due to the connection between positioner 118 and connector 114. The connector 114 is attached to drive piston 46 and can mechanically displace drive piston 46.

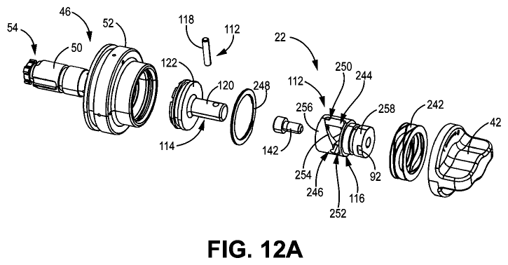

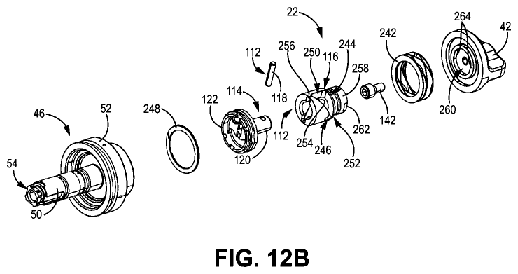

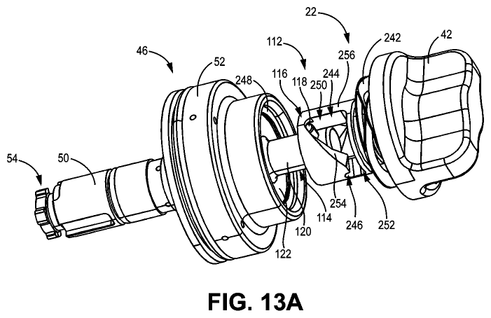

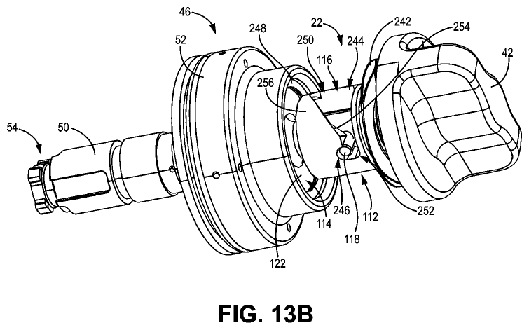

FIG. 12A is a first exploded view of shutoff 22 and drive piston 46. FIG. 12B is a second exploded view of shutoff 22. FIG. 13A is an isometric view of shutoff 22 and drive piston 46 showing the shutoff 22 in an unlocked state. FIG. 13B is an isometric view of the shutoff and drive piston showing the shutoff in a locked state. FIGS. 12A-13B are discussed together and with continued reference to FIGS. 1A-11B. Shutoff 22 includes knob 42, converter 112, connector 114, shutoff fastener 142, and spring 242. Converter 112 includes positioner 118 and converter body 116. Converter body 116 includes lock slots 244, slot body 256, and mount body 258. Connector 114 includes connector shaft 120 and connector head 122.

Shutoff 22 is actuatable between a locked state, in which the shutoff 22 locks the sprayer 10 in the non-spray state, and an unlocked state, in which the sprayer 10 is actuatable between the non-spray and spray states. Shutoff 22 can actuate the sprayer 10 from the spray state to the non-spray state by actuation of the shutoff 22 from the unlocked state to the locked state.

Knob 42 is configured to be disposed at least partially outside of the gun body 30. The knob 42 is accessible by the user form the exterior of sprayer 10. Knob 42 is rotatable on spray axis SA and is configured to actuate the shutoff 22 between the locked and unlocked states. Spring 242 interfaces with knob 42 and is configured to bias knob 42 in second axial direction AD2. The spring 242 is disposed between knob 42 and gun body 30. Spring 242 is shown as a wave spring, though it is understood that other spring types are possible.

Connector 114 is connected to drive piston 46 to move together with drive piston 46 on spray axis SA. In the example shown, connector head 122 is disposed at least partially within piston head 52 of drive piston 46. Retainer 248 is mounted to piston head 52 and axially overlaps with connector head 122. Retainer 248 secures connector head 122 within the chamber formed in piston head 52 of drive piston 46. Retainer 248 fixes connector 114 to drive piston 46.

Converter 112 is connected to knob 42 and to drive piston 46. Converter 112 is indirectly connected to drive piston 46, via connector 114, in the example shown. The converter 112 can translate rotational input from knob 42 into linear movement of drive piston 46 in second axial direction AD2, axially away from spray orifice 28 of mix chamber 110

Positioner 118 is mounted to connector 114. Positioner 118 is mounted to connector shaft 120 in the example shown. Positioner 118 extends fully through connector shaft 120 such that each end of positioner 118 projects radially outward from connector shaft 120. Each radial end of the positioner 118 extends into and is disposed within a lock slot 244.

Converter body 116 is mounted to knob 42 to rotate coaxially with knob 42. In the example shown, the mount body 258 of converter body 116 is disposed at least partially within knob cavity 260 formed within knob 42. Shutoff fastener 142 is disposed at least partially within converter body 116. Shutoff fastener 142 extends through mount body 258 and into knob 42. Shutoff fastener 142 can include exterior threading configured to interface with interior threading within knob 42. Shutoff fastener 142 fixes converter body 116 and knob 42 axially relative to each other.

In the example shown, the mount body 258 is keyed to the knob 42 to prevent relative rotation between mount body 258 and knob 42. The exterior surface of mount body 258 is non-circular and the interior surface of the knob chamber 260 has a corresponding non-circular shape to mate with the exterior surface of mount body 258. In the example shown, the exterior surface of mount body 258 includes converter flats 262 that mate with corresponding knob flats 264 formed on knob 42. It is understood, however, that the keyed interface can be of any desired configuration. For example, the exterior of mount body 258 and interior surface of knob cavity 260 can be hexed, square, oval, triangular, among other non-circular options.

Slot body 256 extends in first axial direction AD1 from mount body 258. Lock slots 244 are formed in slot body 256. Lock slots 244 extend helically about slot body 256 in the example shown. The lock slots 244 extend both axially and circumferentially about the slot body 256. In the example shown, converter body 116 includes a pair of lock slots 244 that the opposite ends of the positioner 118 extend into. The dual slot configuration of converter body 116 balances forces on positioner 118 when shutoff 22 actuates the drive piston 46 in second axial direction AD2, such as in the event of pressure loss, and when shutoff 22 is in the locked state and holding the sprayer 10 in the non-spray state. The interface between converter body 116 and positioner 118 is radially outward of the spray axis SA and the holding forces are balanced by the dual slot configuration.

Each lock slot 244 extends between a free end 250 and a lock end 252. The free end 250 has a longer axial length that the lock end 252. In the example shown, free end 250 is open in first axial direction AD1 to allow positioner 118 to pass into or out of converter body 116 during assembly or disassembly of sprayer 10. Gun body 30 is sized such that positioner 118 remains disposed within lock slot 244 even with drive piston 46 displaced fully in first axial direction AD1 during operation of sprayer 10.

In the example shown, detent 246 is formed at lock end 252. Detent 246 extends in first axial direction AD1 such that a portion of the structure of converter body 116 circumferentially overlaps with detent 246. Detent 246 is configured to receive an end of positioner 118 with shutoff 22 in the locked state.

FIGS. 13A and 13B show actuation of the shutoff 22 between the unlocked state (FIG. 13A, which shows the configuration with the sprayer 10 in a spray state) and the locked state (FIG. 13B). As discussed above, shutoff 22 is configured both to actuate the sprayer 10 from the spray state to the non-spray state in the event of pressure loss and to lock the sprayer 10 in the non-spray state. Shutoff 22 can be actuated to the locked state with the sprayer 10 in either of the spray state or the non-spray state.

To actuate the sprayer 10 from the spray state to the non-spray state, the knob 42 is rotated, which causes rotation of the converter body 116. The ramped surfaces 254 of lock slots 244 interface with the ends of the positioner 118 and causes positioner 118 to translate linearly in second axial direction AD2. The ramped surface 254 is curved to displace positioner 118 as converter body 116 is rotated. Positioner 118 is connected to connector 114 and connector 114 is connected to drive piston 46 such that converter 112 pulls drive piston 46 in second axial direction AD2. The knob 42 is rotated until the positioner 118 reaches the lock end 252 of lock slot 244. The spring 242 biases knob 42 in second axial direction AD2 causing positioner 118 to enter into detent 246. With positioner 118 disposed at lock end 252 of lock slot 244, the sprayer 10 is locked in the non-spray state. With positioner 118 disposed in detent 246, the knob 42 is prevented from freely rotating about spray axis SA to put shutoff 22 in the unlocked state.

To actuate shutoff 22 to the unlocked state, the knob 42 is rotated, which rotates converter body 116. Converter body 116 rotates relative to positioner 118 such that positioner 118 is disposed at the free end 250 of lock slot 244. In the example shown, detent 246 secures shutoff 22 in the locked state. To actuate shutoff 22 to the unlocked state, knob 42 is depressed in first axial direction AD1, compressing spring 242 and shifting converter body 116 in first axial direction AD1 relative to positioner 118. Positioner 118 is thus moved out of the detent 246 and knob 42 can be rotated to place shutoff 22 in the unlocked state.

Shutoff 22 provides significant advantages. Shutoff 22 is actuatable between the locked state and the unlocked state by rotating knob 42. The rotation of knob 42 can cause liner displacement of the drive piston 46 and valve assembly 64 to actuate sprayer 10 from the spray state to the non-spray state. The shutoff 22 can also lock sprayer 10 in the non-spray state to prevent actuation of the sprayer 10 to the spray state. Shutoff 22 provides a single mechanism that can both shut off spraying and lock sprayer 10 to prevent spraying. Shutoff 22 is easily accessible by a user to provide quick actuation of the sprayer 10 to the non-spray state, preventing material loss and preventing undesired spraying in the event of pressure loss. Shutoff 22 interfaces with drive piston 46 to physically lock drive piston 46 to prevent actuation of the sprayer 10 to the spray state. In the example shown, shutoff 22 can be considered to form a trigger lock in that shutoff 22 prevents triggering of sprayer 10 to the spray state, but shutoff 22 does not directly interface with trigger 24. As such, trigger 24 can still be actuated even with the shutoff 22 in the locked state, but such actuation will not cause sprayer 10 to actuate to the spray state.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims. Also, while some options are shown, it is understood that those options do not need to be present, and some aspects could be removed or substituted.

1. A cartridge for use with a plural component spray gun having a spray gun body and configured to receive first and second constituent materials that mix to form a plural component material, the cartridge comprising:
a valving body extending between a first body end and a second body end;
a first flow valve located within the valving body;
a second flow valve located within the valving body; and
a mix chamber cavity extending into the first body end of the valving body along a spray axis, the mix chamber cavity configured to receive at least a portion of a mix chamber of the plural component spray gun;
wherein the cartridge is removable from the spray gun body as a single module; and
wherein removal of the cartridge from the spray gun body necessarily disconnects the mix chamber from any connection with the spray gun body if the mix chamber has not already been removed from the cartridge.

2. The cartridge of claim 1, wherein the mix chamber cavity does not extend through the second body end.

3. The cartridge of claim 1, wherein the mix chamber cavity is open on the first body end of the valving body such that the mix chamber can be removed from the first body end of the valving body, and wherein the mix chamber cavity is partially or entirely closed with respect to the second body end of the valving body such that the mix chamber cannot be moved through the second body end.

4. The cartridge of claim 3, wherein the mix chamber directly contacts the cartridge and is removable to be out of contact with the cartridge, but the mix chamber is not in direct contact with the spray gun body during spraying.

5. (canceled)

6. The cartridge of claim 1, wherein:
the valving body defines a first material passage between a first material inlet and the mix chamber cavity;
the valving body defines a second material passage between a second material inlet and the mix chamber cavity; and
the first material passage and the second material passage are fluidly separated such that the first and second constituent materials flow into the valving body separately and move out of the first body end mixed together to form the plural component material.

7. The cartridge of claim 1, wherein the first body end is configured to connect to an air cap, and wherein the air cap retains the mix chamber within the cartridge, and detachment of the air cap from the cartridge permits removal of the mix chamber from the cartridge from out of the first body end of the cartridge.

8. (canceled)

9. (canceled)

10. The cartridge of claim 1, further comprising:
a first valve bore extending into the valving body from the second body end along first valve axis offset from the spray axis;
a second valve bore extending into the valving body from the second body end along a second valve axis offset from the spray axis;
wherein the first flow valve is disposed within the first valve bore; and
wherein the second flow valve is disposed within the second valve bore.

11. The cartridge of claim 10, wherein the first valve bore and the second valve bore are not open through the first body end.

12. (canceled)

13. The cartridge of claim 10, wherein:
a first gas chamber is formed within the first valve bore;
a first flow chamber is formed within the first valve bore;
the first gas chamber is fluidly connected to the mix chamber bore with the first flow valve in a first open state such that compressed gas can flow to the mix chamber bore from the first gas chamber; and
the first flow chamber is fluidly connected to the mix chamber bore with the first flow valve in a second open state such that a constituent material can flow to the mix chamber bore from the first flow chamber.

14. (canceled)

15. The cartridge of claim 10, wherein a first feed bore is formed in the valving body and extends between and fluidly connects the first valve bore and the mix chamber cavity, and a second feed bore is formed in the valving body and extends between and fluidly connects the second valve bore and the mix chamber cavity.

16. (canceled)

17. The cartridge of claim 1, wherein an entirety of the first flow valve and an entirety of the second flow valve are removed from the plural component spray gun with the cartridge.

18. The cartridge of claim 1, wherein a body coupling is formed at the second body end, the body coupling configured to interface with the spray gun body to form a static interface that supports the cartridge on the spray gun body.

19. (canceled)

20. (canceled)

21. The cartridge of claim 1, further comprising:
a body cavity formed in the valving body and open through the second body end;
a valve assembly at least partially disposed in the body cavity, the valve assembly movable along the spray axis to actuate the first flow valve and the second flow valve to open and close flowpaths to the mix chamber cavity.

22. The cartridge of claim 21, wherein a cavity wall is formed at an axial end of the body cavity, the cavity wall disposed between the first body end and the second body end.

23. The cartridge of claim 1, further comprising:
a body cavity formed in the valving body and open through the second body end;
a first valve bore extending into the valving body and open to the body cavity;
a second valve bore extending into the valving body and open to the body cavity;
a valve assembly at least partially disposed in the body cavity, the valve assembly movable along the spray axis to actuate the first flow valve and the second flow valve to open and close flowpaths to the mix chamber cavity, the valve assembly comprising:
a first valve member at least partially disposed in the first valve bore and movable along the first valve bore;
a second valve member at least partially disposed in the second valve bore and movable along the second valve bore; and
a coupler connected to each of the first valve member and the second valve member, the coupler at least partially disposed within the body cavity.

24. The cartridge of claim 23, further comprising:
a first seal body disposed within the first valve bore, the first flow valve formed between the first seal body and the first valve member;
a second seal body disposed within the second valve bore, the second flow valve formed between the second seal body and the second valve member.

25. The cartridge of claim 24, wherein the first valve member is configured to slide along a valve axis of the first valve bore and relative to the first seal body.

26. The cartridge of claim 25, wherein the first valve member is sealingly engaged with the first seal body with the first flow valve open to allow the first constituent material to flow to the mix chamber bore and with the first flow valve closed to block the first constituent material from flowing to the mix chamber bore.

27. A plural component spray gun configured to receive a first constituent material and a second constituent material and output a spray of a plural component material, the plural component spray gun comprising:
a gun body;
a handle projecting from the gun body;
a trigger supported by the gun body;
a cartridge removably mountable to the gun body, the cartridge comprising:
a valving body extending between a first body end and a second body end, the second body end configured to interface with the gun body to connect the cartridge to the gun body;
a first flow valve located within the valving body;
a second flow valve located within the valving body; and
a mix chamber cavity extending into the first body end of the valving body along a spray axis;
wherein the cartridge is removable from the spray gun body as a single module;
a mix chamber mountable within the mix chamber cavity;
wherein removal of the cartridge from the gun body necessarily disconnects the mix chamber from any connection with the spray gun body if the mix chamber has not already been removed from the cartridge.

28.-37. (canceled)

38. A cartridge for use with a plural component spray gun having an actuator assembly including a spray gun body and a displacer, the cartridge configured to receive first and second constituent materials that mix to form a plural component material, the cartridge comprising:
a valving body extending between a first body end and a second body end along an axis;
a mix chamber cavity formed in the valving body;
a first flow valve located within the valving body;
a second flow valve located within the valving body;
a valve mount configured to interface with the actuator assembly at a dynamic interface to receive a mechanical input to actuate the first flow valve and the second flow valve between respective first states, in which flows of the first constituent material and the second constituent material to the mix chamber cavity are closed, and respective second states, in which the flows of the first constituent material and the second constituent material to the mix chamber cavity are open; and
a body mount formed on the valving body and configured to interface with the actuator assembly at a static interface to mount the cartridge to the spray gun body;
wherein the cartridge is mountable to and dismountable from the actuator assembly as a single unit.

39.-192. (canceled)
